(19) United States
(12) Patent Application Publication
(10) Pub. No.: US 2016/0328739 A1
(43) Pub. Date: Nov. 10, 2016

(54) ATTRIBUTION OF VALUES TO USER INTERACTIONS IN A SEQUENCE

(71) Applicant: Kenshoo Ltd., Tel Aviv (IL)

(72) Inventors: Joseph Synett, Tel Aviv (IL); Arriel Johan Benis, Gan Yavne (IL); Gilad Armon-Kest, Amirim (IL); Moti Meir, Modi'in (IL); Roy Ravid, Kfar Saba (IL); Dorit Zilberbrand, Givar Shmuel (IL); Jacob H. Oaknin, Bat Hefer (IL)

(73) Assignee: Kenshoo Ltd., Tel Aviv (IL)

(21) Appl. No.: 15/215,376

(22) Filed: Jul. 20, 2016

Related U.S. Application Data
(63) Continuation-in-part of application No. 13/598,925, filed on Aug. 30, 2012, now abandoned.
Application No. 13/598,925 is a continuation-in-part of application No. 13/692,071, filed on Dec. 3, 2012.
(60) Provisional application No. 61/595,241, filed on Feb. 6, 2012.
(60) Provisional application No. 61/595,241, filed on Feb. 6, 2012.

(51) Int. Cl. G06Q 30/02

(52) U.S. Cl. CPC G06Q 30/0245; G06Q 30/0275; G06Q 30/0246

(57) ABSTRACT

There is provided, in accordance with some embodiments, a computerized method executed by one or more hardware processors, comprising receiving interaction records, where some of the interaction records comprise a cookie value, a URL (Uniform Resource Locator), and a time stamp. The computerized method comprises computing, from the interaction records, interaction sequences each comprising user interactions. Each adjacent pair of user interactions in each interaction sequence has the same unique user identifier, and attributing at least two interaction values to respective user interactions, where the sum of attributed interaction values is equal to the total value, and where each interaction value is computed using rule(s), respective property values, and the total value. The computerized method comprises updating one or more bidding property on an advertising platform based on the attribution, where the bidding property comprises an advertisement bid value or an advertisement keyword.

### RELATED APPLICATIONS

This application is a continuation-in-part of U.S. patent application Ser. No. 13/598,925 filed Aug. 30, 2012, entitled “System, Method And Computer Program Product For Attributing A Value Associated With A Sequence Of User Interactions To Individual Interactions In The Sequence”, and of Ser. No. 13/692,071 filed Dec. 3, 2012, entitled “System, Method And Computer Program Product For Prediction Based On User Interactions History”, which both claim priority from U.S. Provisional Applications No. 61/595,241, filed Feb. 6, 2012, entitled “System, Method And Computer Program Product For Attributing A Value Associated With A Sequence Of User Interactions To Individual Interactions In The Sequence”, which are incorporated herein by reference in their entirety.

### FIELD OF THE INVENTION

This invention relates to the field of online advertising technology.

### BACKGROUND OF THE INVENTION

Online advertising technologies facilitate computer user to purchase products over the Internet, such as by facilitating interactions between the user and the Internet. For example, an interaction may be when a user is presented with an online advertisement using the web browser of a computer terminal, the user clicks on the advertisement, such as a click through, the web browser may be redirected to a landing page where the user can purchase the product. For example, an interaction may be when a user purchases the product, such as a conversion, by adding clicking on a “add to cart” button on the landing page, navigating the web browser to the checkout page, and completing the purchase.

Other examples of interactions may include a user searching for a product on a search engine web site, such as Google®, searching for a review on a technical review web site, such as CNet®, reading customer reviews on an online seller's web site, such as Amazon®, marking a friend's post describing a product with a “like” on a social network web site, such as on Facebook®, a user sharing a post discussing a product with a second user, a user sending an email to a second user recommending a product, a user clicking on a thumbnail of a product to view the full image on an image repository web site, such as Instagram®, and/or the like.

The sequences of interactions between the first time a user performs an interaction regarding a product and a final outcome, such as a click through, conversion, and/or the like, may be a simple single step interaction, a serial sequence of interactions, such as each interaction leading to the next interaction in the sequence, a complex sequence involving branches, and offshoot sequences, and the like. In routine and conventional online advertising, the attribution of the final outcome may be to the first interaction, and intermediate interaction, such as the presentation of an advertisement and subsequent click through, a last interaction previous to the final outcome, and/or the like. The attribution may be used by one or more stakeholders in the final outcome to determine the performance of one or more online advertising campaigns regarding the product.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a computerized method executed by one or more hardware processors, comprising receiving interaction records, where some of the interaction records may comprise a cookie value, a URL (Uniform Resource Locator), and a time stamp, where the cookie value may comprise one or more unique user identifier. The computerized method may comprise computing, from the interaction records, two or more interaction sequences each comprising two or more user interactions. Each adjacent pair of user interactions in each interaction sequence may have the same unique user identifier. One or more property value may be computed for each of at least some of the user interactions. Each of the interaction sequences may be ordered according to the time stamps. The computerized method may comprise, for each of the interaction sequences, receiving an identification of a target interaction of the interaction sequence, and a total value associated with the target interaction. The computerized method may comprise, for each of the interaction sequences, attributing at least two interaction values to respective at least two user interactions, where the sum of attributed interaction values may be equal to the total value, and where each interaction value may be computed using one or more rule, respective property values, and the total value. The computerized method may comprise updating one or more bidding property on one or more advertising platform based on the attribution, where the bidding property may comprise an advertisement bid value or an advertisement keyword.

In some embodiments, one or more of the user interactions of each interaction sequence may comprise a communication of a digital media over a network connection.

In some embodiments, the one or more rule may comprise an assessment scheme, where the assessment scheme may comprise two or more rules according to which apportionments of the interaction values may be attributed to two or more of user interactions in the interaction sequence.

In some embodiments, the one or more property value quantifies a relative quality of the respective user interaction.

In some embodiments, the one or more property value may comprise types of advertisement channels used by the respective user interaction.

In some embodiments, each of some of the unique user identifiers may be assigned a user values according to interaction values associated of that user within multiple respective interaction sequences

In some embodiments, the target interaction may be a future interaction not recorded in the interaction records.

In some embodiments, the target interaction may be one of the user interactions in the interaction sequences.

In some embodiments, the target interaction represents at least on interaction from the group consisting of an impression, a click-through, and a conversion.

In some embodiments, the computerized method of claim further may comprise statistically analyzing the attributions of two or more interaction sequence, and determining one or more attribution pattern based on a result of the analyzing.

In some embodiments, the statistical analysis may be based on frequencies of attribution patterns of user interactions having similar respective property values.

In some embodiments, the statistical analysis may be applied to a subset of user interactions in at least some of the interaction sequences.

In some embodiments, the statistical analysis differentiates between interaction patterns comprising high target interaction values with respect to interaction patterns comprising low target interaction values.

In some embodiments, the computerized method further may comprise computing multiple possible future interactions which may occur after the target interaction of a target sequence, where each possible future interaction may be a server initiated interaction, and where each possible future interaction defines a possible future sequence.

In some embodiments, the computerized method further may comprise computing attributions and a performance assessment for each possible future sequence.

In some embodiments, the computerized method further may comprise selecting one of the possible future interactions based on the performance assessment.

In some embodiments, the computerized method further may comprise executing the selected possible future interaction.

In some embodiments, the selecting may comprise selecting an advertisement out of multiple possible advertisements, where the executing may comprise presenting the selected advertisement to the respective user, and where the method may be used for retargeting a selected user with an advertisement which may be selected based on previous user interactions with the respective user.

In some embodiments, the one or more property value may comprise one or more value which may be unrelated to a time in which any of the interactions occurred.

In some embodiments, the attributions are performed in a hierarchal manner to one or more subset of multiple user interactions of the interaction sequence.

In some embodiments, the attribution may be based on a pattern occurring in one or more property value of the user interactions across the respective interaction sequence.

There is provided, in accordance with an embodiment, a computerized system, comprising an interface, one or more hardware processors, and a non-transitory storage medium. The non-transitory storage medium may comprise instructions executable on the hardware processors. The instructions are configured for receiving interaction records, where each of at least some of the interaction records may comprise a cookie value, a URL (Uniform Resource Locator), and a time stamp, where the cookie value may comprise one or more unique user identifier. The instructions are configured for computing, from the interaction records, two or more interaction sequences each comprising two or more user interactions. Each adjacent pair of user interactions in each interaction sequence has the same unique user identifier. One or more property value may be computed for each of at least some of the interaction records. Each of the interaction sequences may be ordered according to the time stamps. For each of the interaction sequences, the instructions are configured for receiving an identification of a target interaction of the interaction sequence, and a total value associated with the target interaction. For each of the interaction sequences, the instructions are configured for attributing at least two interaction values to respective at least two user interactions, where the sum of attributed interaction values may be equal to the total value, and where each interaction value may be computed using one or more rule, respective property values, and the total value. The instructions are configured for updating one or more bidding property on one or more advertising platform based on the attribution, where the bidding property may comprise one or more of an advertisement bid value and an advertisement keyword.

There is provided, in accordance with an embodiment, a computer program product, stored on a non-transitory computer readable storage medium, where the computer program product may comprise instructions executable on one or more hardware processors. The instructions are configured for receiving interaction records, where each of at least some of the interaction records may comprise a cookie value, a URL (Uniform Resource Locator), and a time stamp, where the cookie value may comprise one or more unique user identifier. The instructions are configured for computing, from the interaction records, two or more interaction sequences each comprising two or more user interactions. Each adjacent pair of user interactions in each interaction sequence has the same one or more unique user identifier. One or more property value may be computed for each of at least some of the interaction records. Each of the interaction sequences may be ordered according to the time stamps. For each of the interaction sequences, the instructions are configured for receiving an identification of a target interaction of the interaction sequence, and a total value associated with the target interaction. For each of the interaction sequences, the instructions are configured for attributing at least two interaction values to respective at least two user interactions, where the sum of attributed interaction values may be equal to the total value, and where each interaction value may be computed using one or more rule, respective property values, and the total value. The instructions are configured for updating one or more bidding property on one or more advertising platform based on the attribution, where the bidding property may comprise one or more of an advertisement bid value and an advertisement keyword.

In addition to the exemplary aspects and embodiments described herein, further aspects and embodiments will become apparent by reference to the figures and by study of the following detailed description.

### BRIEF DESCRIPTION OF THE DRAWINGS

Exemplary embodiments are illustrated in referenced figures. Dimensions of components and features shown in the figures are generally chosen for convenience and clarity of presentation and are not necessarily shown to scale. For example, the dimensions of some of the elements may be exaggerated relative to other elements for clarity. Further, where considered appropriate, reference numerals may be repeated among the figures to indicate corresponding or analogous elements.

The figures are listed below.

FIG. 1 shows a schematic illustration of a system for computing values associated with individual interactions in a sequence;

Each of FIGS. 2A through 2E show schematic illustrations of example sequences of interactions;

Each of FIGS. 2F and 2G show schematic illustrations of example attributions of values to interactions in sequences;

Each of FIGS. 3 through 9 show flowcharts of example computerized methods for attribution of values to interactions in sequences;

FIG. 10 shows a schematic illustration of example pattern determinations of interactions in a sequence and value attribution; and

FIG. 11 shows a schematic illustration of alternative future sequences of interactions leading to a desired outcome.

### DETAILED DESCRIPTION OF EMBODIMENTS

Disclosed are systems, methods, and computer program products for computing a value associated with each step in a sequence of interactions leading to an outcome. An interaction may be between a user and a web site and/or system, such as when a system presents digital media to a user and receives a user response, or the user inputs data to a web site and receives a response from a server. An outcome may be a click-through, a conversion, and/or the like, and has a total value associated with the sequence. Once individual interaction values are computed in multiple sequences, the history of sequences leading to the same or similar final outcomes may be analyzed to determine patterns, user preferences, and the like. The analysis results may in turn be used to make predictions on improving the final outcome performance. For example, historic analysis and predictions may lead to an increase in bid values and/or number of bids for a particular online advertisement channel, such as Facebook® advertising and/or the like. For example, historic analysis and predictions may lead to a decrease in bid values and/or number of bids. For example, historic analysis and predictions may be used to modify the bid values in a future interaction sequence, such as to reduce the bid value of a first and second advertisement presentation to a user, and increase the bid value of a third advertisement presentation to a user.

Disclosed are systems, methods, and computer program products for tracking a sequence of network interaction resulting in an outcome, where each interaction comprises sending and receiving interaction record data over a computer network. By setting a value for the contribution of each interaction in the sequence to the final outcome, given the total value of the outcome, the individual interactions can be rated. By comparing multiple sequences of historic data for the same outcomes, similar outcomes, inverse outcomes, and the like, the interactions with positive contribution values can be identified. Positive contribution interactions may be used to save network data transfer, simplify the interaction sequence, improve resource allocation efficiency, and/or the like, for a given desired outcome, such as a target interaction. For example, an interaction with a positive contribution value may be used to determine a bid value for an advertisement in response to the same or similar interactions. For example, an interaction with a low contribution value may be used to remove a keyword for future interactions, such as an advertisement keyword, and thus save in network transfer of ineffective advertisements. For example, positive contribution values are used to determine the interactions of a specific advertisement channel, such as a Facebook® advertisement channel, may be more effective and a subsequent advertising budget value may be increased for the specific advertisement channel.

Optionally, historic patterns of interaction sequences are identified from the historic data, and the patterns are used to rate interaction contribution values of new sequences by comparing the pattern in the new sequences to the historic patterns. As used herein, the term pattern is used to mean identified common sequences of user interactions from statistical analysis of historical interaction sequences. As used herein, the term scheme is used to mean the rules associated with attribution of value to user interactions in a sequence, based on the type, property, position in the sequence, and/or the like.

Optionally, future interaction sequences can be assessed according to matching the patterns determined from historic sequences. For example, a pattern identified as not producing a desired outcome, such as a target interaction, can be identified during a sequence of interactions, and a bid value reduced so that an online advertisement may not be presented to a user.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “processing”, “calculating”, “determining”, “generating”, “setting”, “configuring”, “selecting”, “assigning”, “attributing”, “computing”, or the like, include action and/or processes of a computer that manipulate and/or transform data into other data, the data represented as physical quantities, e.g., such as electronic quantities, and/or the data representing the physical objects. The terms “computer”, “processor”, “processing module” and like terms should be expansively construed to cover any kind of electronic device with data processing capabilities, including, by way of non-limiting example, a personal computer, a server, a computing system, a communication device, a processor (e.g., digital signal processor (DSP), a microcontroller, a field programmable gate array (FPGA), an application specific integrated circuit (ASIC), and/or the like), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more steps illustrated in the figures may be executed in a different order and/or one or more groups of steps may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

Following is a glossary of terms used in this application.

“Online advertising platform” (or simply “advertising platform”): This term, as referred to herein, may relate to a service offered by an advertising business to different advertisers. In the course of this service, the advertising business serves ads, on behalf of the advertisers, to Internet users. Each advertising platform usually services a large number of advertisers, who compete on advertising resources available through the platform. The competition may be carried out by conducting some form of an auction, where advertisers bid on advertising resources. The ads may be displayed (and/or otherwise presented) in various web sites affiliated with the advertising business (these web sites constituting what may often be referred to as a “display network”) and/or in one or more web sites operated directly by the advertising business. To aid advertisers in neatly organizing their ads, advertising platforms often allow grouping individual ads in sets, such as the “AdGroups” feature in Google® AdWords® (a service operated by Google, Inc. of Mountain View, Calif.). The advertiser may decide on the logic behind such grouping, but it may be common to have ads grouped by similar ad copies, similar targeting, and/or the like. Advertising platforms may allow an even more abstract way to group ads; this may be called a “campaign”. A campaign usually includes multiple sets of ads, with each set including multiple ads. An advertiser may control the cost it spends on online advertising by assigning a budget per individual ad, a group of ads or the like. The budget may be defined for a certain period of time.

“Search advertising platform”: A type of advertising platform where ads may be served to Internet users responsive to search engine queries executed by the users. The ads may be displayed alongside the results of the search engine query. AdWords may be a prominent example of a search advertising platform. In AdWords, advertisers can choose between displaying their ads in a display network and/or in Google®'s own search engine; the former involves the subscription of web site operators (often called “publishers”) to Google®'s AdSense® program, whereas the latter, often referred to as SEM (Search Engine Marketing), involves triggering the displaying of ads based on keywords entered by users in the search engine.

“Social advertising platform”: A further type of advertising platforms, such as a “social” advertising platform, involves the displaying of ads to users of online social networks. An online social network may be defined as a set of dyadic connections between persons and/or organizations, enabling these entities to communicate over the Internet. In social advertising, both the advertisers and the users enjoy that the displayed ads can be highly tailored to the users viewing them. This feature may be enabled by way of analyzing various demographics and/or other parameters of the users (jointly referred to as “targeting criteria”)—parameters which may be available in many advertising platforms of social networks and may be provided by the users themselves. Facebook® Ads, operated by Facebook®, Inc. of Menlo Park, Calif., may be such an advertising platform. LinkedIn Ads, by LinkedIn Corporation of Mountain View, Calif., may be another advertising platform.

“Online ad entity” (or simply “ad entity”): This term, as referred to herein, may relate to an individual ad, or, alternatively, to a set of individual ads, run by an advertising platform. An individual ad, as referred to herein, may include an ad copy, which may be the text, graphics and/or other media to be served (displayed and/or otherwise presented) to users. The ad copy may also include a link, in Uniform Resource Locator (URL) format, to a landing page. The term “landing page” refers to a web page, such as in Hypertext Markup Language (HTML) format. In addition, an individual ad may include and/or be associated with a set of parameters, such as searched keywords to target, geographies to target, demographics to target, a bid for utilization of advertising resources of the advertising platform, and/or the like. Sometimes, the bid may set for a particular parameter instead of or in addition to setting a global bid for the ad entity; for example, a bid may be per keyword, geography, and/or the like.

“Reach”: the number of users which fit certain targeting criteria of an ad entity. This may be the number of users to which that ad entity can be potentially displayed. The “reach” metric may be common in social advertising platforms, such as Facebook®.

“Search volume”: the number of average monthly searches (or searches over another period of time) for a certain search term. The search volume may be provided by search advertising platforms, such as Google® AdWords®.

“Performance”: This term, as referred to herein with regard to an ad, may relate to various statistics gathered in the course of running the ad. A “running” phase of the ad may refer to a duration in which the ad was served to users, or at least to a duration during which the advertiser defined that the ad should be served. The term “performance” may also relate to an aggregate of various statistics gathered for a set of ads, a campaign, and/or the like. The statistics may include multiple parameters (also “performance metrics”). Exemplary performance metrics may be:
“Impressions”: the number of times the ad has been served to users during a given time period (e.g. a day, an hour, and/or the like);
“Frequency”: the average number of times a user has been exposed to the same ad, calculated as the ratio of total number of impressions to the number of unique impressions (i.e. the number of unique users exposed to that ad). This metric may be very common in social advertising platforms;
“Clicks”: the number of times users clicked (or otherwise interacted with) the ad entity during a given time period (e.g. a day, an hour, and/or the like);
“Cost per click (CPC)”: the average cost of a click (or another interaction with an ad entity) to the advertiser, calculated as the total cost for all clicks divided by the number of clicks;
“Cost per impression”: the average cost of an impression to the advertiser, calculated as the total cost for impressions divided by the number of impressions;
“Click-through rate (CTR)”: the ratio between clicks and impressions of the ad entity, namely—the number of clicks divided by the number of impressions;
“Conversions”: the number of times in which users who clicked (or otherwise interacted with) the ad entity has consecutively accepted an offer made by the advertiser during a given time period (e.g. a day, an hour, and/or the like). For examples, users who purchased an advertised product, users who subscribed to an advertised service, users who downloaded a mobile application, or users who filled in their details in a lead generation form;
“Conversion rate (CR)”: the total number of conversions divided by the total number of clicks;
“Return on investment (ROI)” or “Return on advertising spending (ROAS)”: the ratio between the amount of revenue generated as a result of online advertising, and the amount of investment in those online advertising efforts. Namely—revenue divided by expenses;
“Revenue per click”: the average amount of revenue generated to the advertiser per click (or another interaction with an ad entity), calculated by dividing total revenue by total clicks;
“Revenue per impression”: the average amount of revenue generated to the advertiser per impression of the ad entity, calculated by dividing total revenue by total impressions;
“Revenue per conversion”: the average amount of revenue generated to the advertiser per conversion, calculated by dividing total revenue by total conversions;
“Unique-impressions-to-reach ratio”: the ratio between the number of unique impressions (i.e. impressions by different users, ignoring repeated impressions by the same user) and the reach of the ad entity. This ratio represents the realized portion of the reach.
“Spend rate”: the percentage of utilized budget per a certain time period (e.g. a day) for which the budget was defined. In many scenarios, even if an advertiser assigns a certain budget for a certain period of time, not the entire budget may be consumed during that period. The spend rate metric measures this phenomenon.
“Quality score”: a score often provided by advertising platforms for each ad entity. For example, Google® AdWords® assigns a quality score between 1 and 10 to each individual ad. Factors which determine the quality score include, for example, CTR, ad copy relevance, landing page quality and/or other factors. The quality score, together with the bids placed by the advertiser, may be the factors which affect the results of the competition between different advertisers on advertising resources.
“Potential reach”: defined as 1 minus the unique-impressions-to-reach ratio. The higher the potential reach, the more users may be available to display the ad entity to.

“Proportional performance metrics”: those of the performance metrics (or other performance metrics not discussed here) which denote a proportion between two performance metrics which may be absolute values. Merely as one example, CTR may be a proportional performance metric since it denotes the proportion between clicks (an absolute value) and impressions (another absolute value). As an alternative, a proportional performance metric may be a proportion between an absolute performance metric and another parameter, such as time. As yet another alternative, a proportional performance metric may be a certain mathematic manipulation of a proportion between two absolute performance metrics; the “potential reach” may be an example, since it may be defined as 1 minus the unique-impressions-to-reach ratio.

“Hypertext Transfer Protocol” (or simply “HTTP”): An Internet application protocol for distributed, collaborative, hypermedia information systems over the Internet. HTTP may be the foundation of data communication for the World Wide Web (WWW). Hypertext may be structured text that uses logical links (hyperlinks) between nodes containing text.

“HTTP Cookie” (or simply “cookie”): As defined in A. Barth, “HTTP State Management Mechanism”, IETF, RFC 6265, April 2011. [Online]. Available at: http://tools.ietf.org/html/rfc6265. This RFC is incorporated herein by reference in its entirety. A cookie contains a plurality of values and may comprise a user identifier, one or more user interaction data, and the like.

“Web Browser”: a software application running on a client terminal that may be used by a user to access internet resources.

“Web Client”: any type of application that can request internet resources, advertisements, redirection requests, and/or the like from a server. For example, a software robot, a web browser, a second server, and/or the like may be considered web clients.

“HTTP log file” (or simply “logfile”): a text file containing formatted lists of HTTP requests received by a server from multiple client terminals. Many HTTP log formats contain one line per request, where the line may contain an IP address of the dine which made the request, a user-identifier may be the RFC 1413 identity of the client, a userid of the person requesting the electronic document, a time-stamp, such as a date, a time, and a time zone that the request was received, a request line from the client, a HTTP status code returned to the client, such as 2xx for a successful response, 3xx for a redirection, 4xx for a client error, 5xx for a server error, and the like, the size of the object returned to the client, such as measured in bytes, and/or the like. Other formats may be possible, such as the extended log file format as described in W3C Working Draft WD-logfile-960323, the National Center for Supercomputing Applications (NCSA) Common log format, NCSA extended log format, and the like.

“desired outcome” (or simply “outcome”): one or more of the performance metrics may be the desired outcome of a sequence of events, and an outcome may have a total value which is associated with the sequence. An optional interaction, such as a target interaction, may be a desired outcome. For example, an outcome may be a conversion, a click-through, an impression, a customer satisfaction, a high review rating, an/or the like.

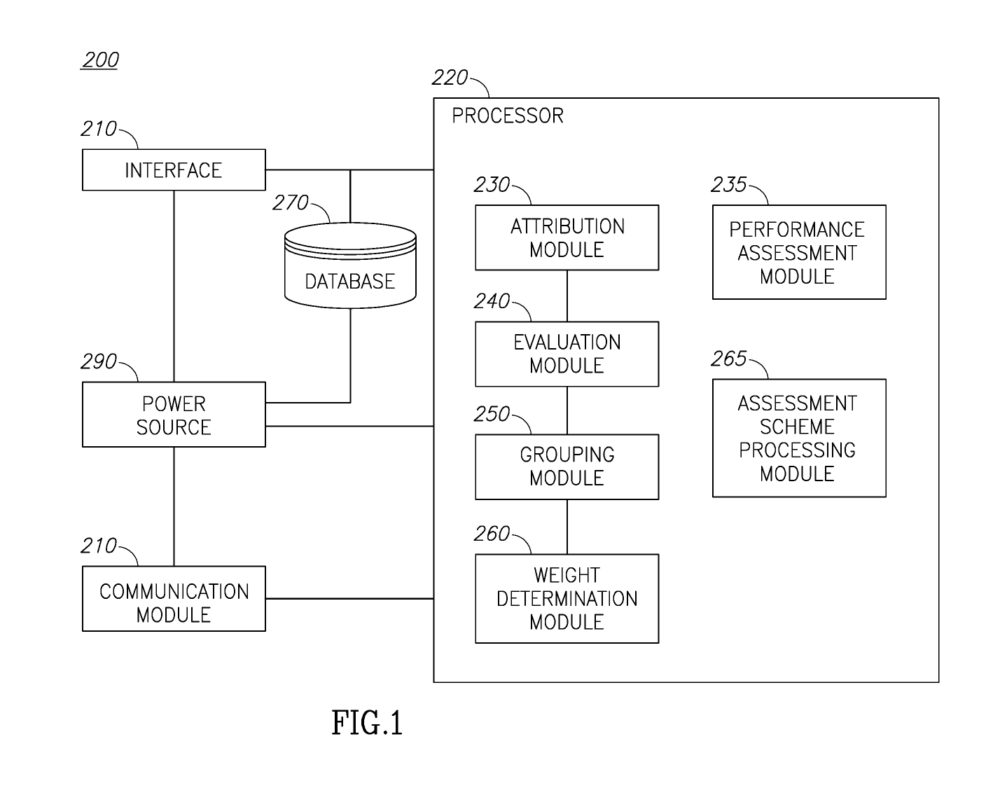

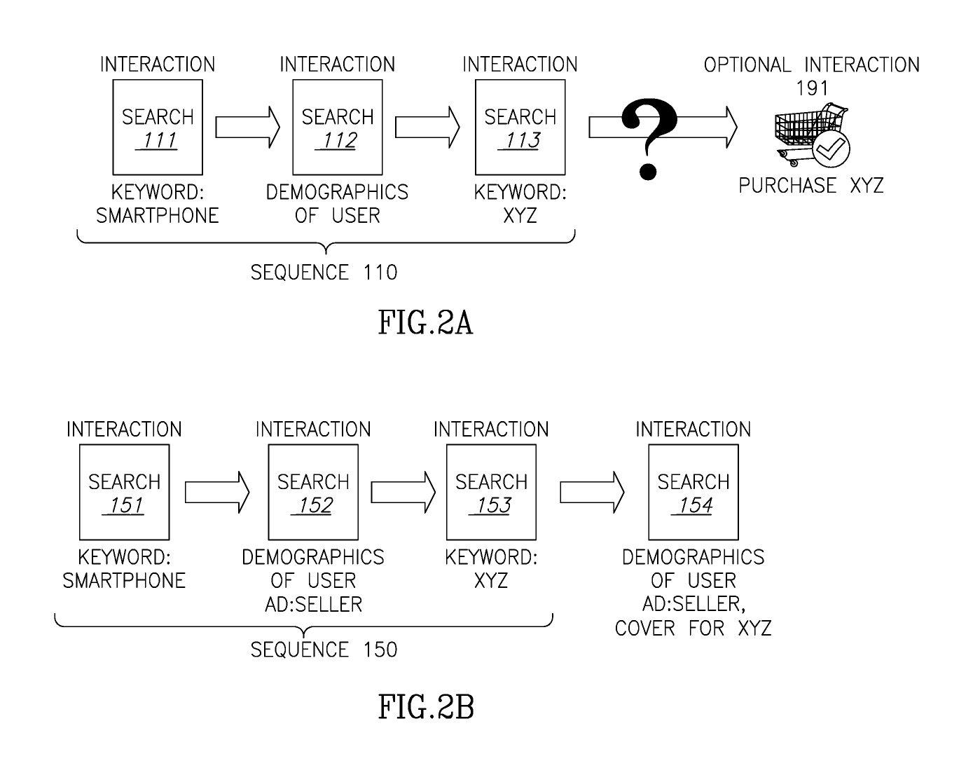

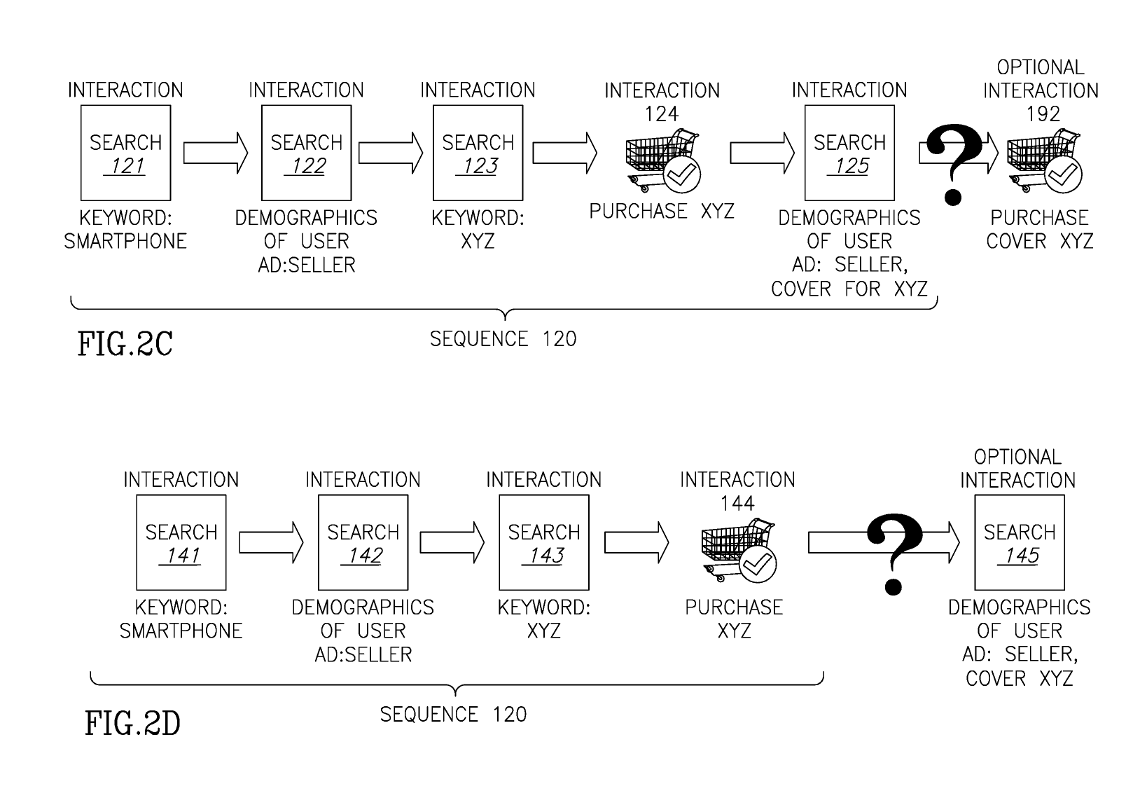

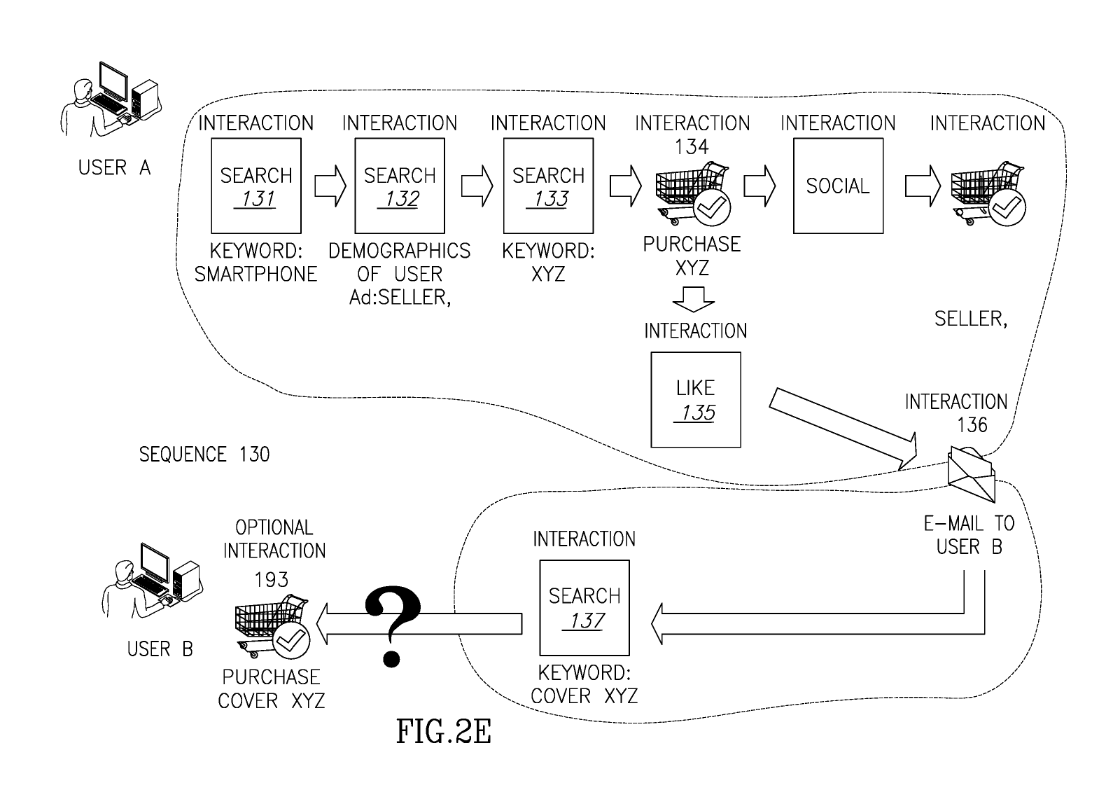

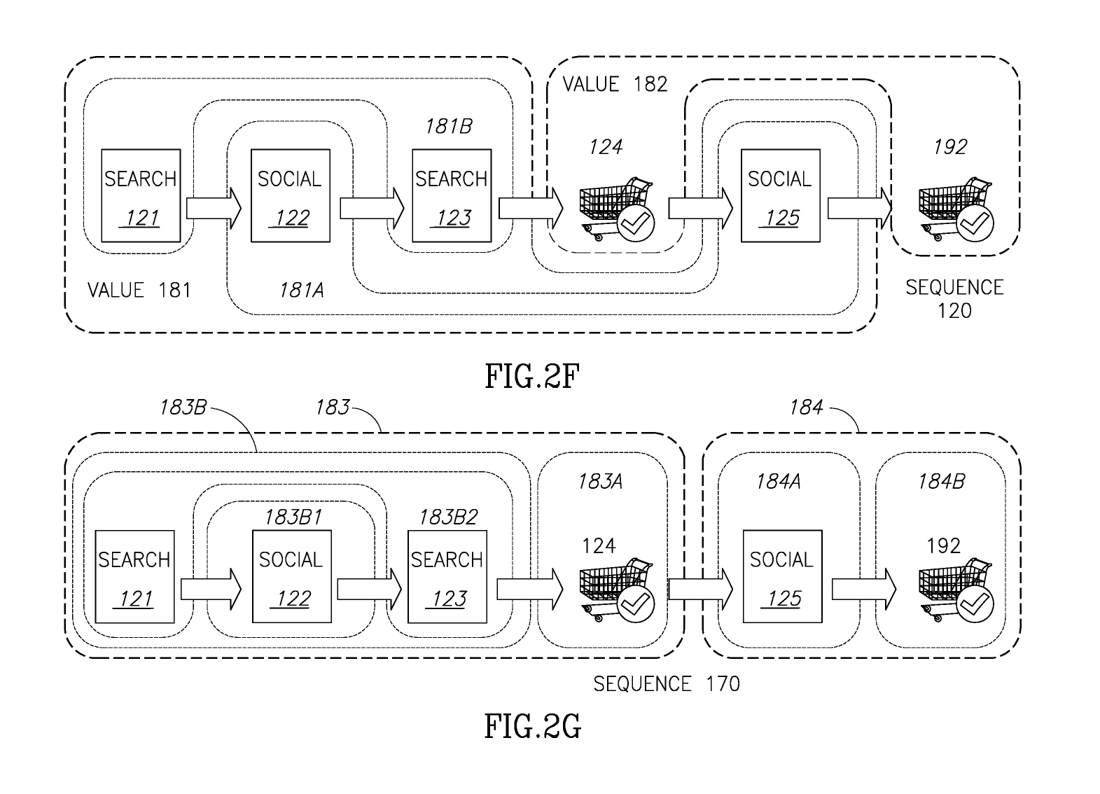

Reference is now made to FIG. 1, which shows a schematic illustration of a system 200 for computing values associated with individual interactions in a sequence. System 200 includes interface 210 which may be configured to obtain information of interactions, such as cookies, log files, conversion reports, redirection reports, electronic documents, and/or the like. For example, a log file contains a data associated with a server access and/or request by a user, such as a redirection request when the user clicked an advertisement. For example, a log file contains a data item regarding a keyword sent by the user to a search engine and a subsequent presentation of an advertisement on the web browser of the user's computer. The interactions may be included in sequences of interactions and one or more processors 220, for executing program code stored in processing modules. At least one of the interactions of the sequence includes communication of digital media over a network connection. System 200 may include various additional components (such as power source 290), which may be used for effective operation of system 200. Some components may not be necessary for the understanding of the embodiments and may not be illustrated, thereby making the discussion clearer.

One of the modules whose program code is executed on processor 220 may be attribution module 230 that assigns a value to each interaction in the sequence, based on properties relating to at least one interaction out of the sequence of interactions. Performance assessment module 235 may be configured to compute a performance assessment for the sequence of interactions, based on the obtained information, such as the information obtained by interface 210, and further based on a statistical analysis of historical data of a plurality of interaction sequences.

The obtained information, on which performance assessment module 235 bases its computing of the performance assessment, may be property and/or parameter values of individual interactions of each sequence, or on properties of a subset of sequences, such as by computing patterns. Optionally the group of properties, on which the computing may be based, includes at least one property value which may be unrelated to a time in which any of the interactions occurred. Specifically, at least one of the properties may be not related to any of the following:
a. a time in which any of the interactions occurred;
b. time passed between any two of more of the interactions of the sequence;
c. time passed between any of the interactions to another event or point in time;
d. relation of order between any two or more of the interactions of the sequence.

Some of the properties of the interactions may be related to time (e.g., in addition to other properties such as the type of channel over which one or more of the interactions occurred).

Optionally, attribution module 230 may be configured to attribute the apportionments of the value based on properties quantifying relative quality of the interactions. Optionally, attribution module 230 may be configured to attribute the apportionments of the value based on types of communication or advertisement channels used by the respective interactions.

Optionally, attribution module 230 may be configured to attribute the apportionments of the value based on properties of at least one subset of interactions of the sequence, wherein the subset includes multiple interactions.

Optionally, attribution module 230 may be configured to attribute the apportionments of the value based on properties of elements that triggered interactions of the sequence.

Optionally, attribution module 230 may be configured to attribute the apportionments of the value based on properties which pertain to an advertised entity associated with one or more interactions of the sequence of interactions.

Optionally, attribution module 230 may be configured to attribute the apportionments of the value based on properties of at least one keyword entered by a user which triggered at least one interaction of the sequence.

Optionally, attribution module 230 may be configured to attribute values to interactions of multiple interconnected sequence of user interactions which may be associated with multiple users.

Optionally, attribution module 230 may be configured to attribute the apportionments of the value based on properties which pertain to an advertisement provided to a user in at least one of the interactions of the sequence.

Optionally, attribution module 230 may be configured to attribute the apportionments of the value based on a pattern occurring in at least one property value of the interactions across the sequence of interactions.

Optionally, attribution module 230 and/or performance assessment module 235 may be configured to perform computations based on the properties relating to one or more interactions, one or more sequences, a calibrated attribution scheme, and/or the like.

Optionally, attribution module 230 may be configured to attribute the value based on weights which may be determined based on a statistical analysis of historical data of a plurality of sequence of interactions with a plurality of users.

Optionally, interface 210 may be further configured to obtain information indicative of relations between values previously attributed to interactions of a previously analyzed sequence of interactions that may be associated with the conversion; wherein attribution module 230 may be configured to attribute values to interactions of the previously analyzed sequence based on the relations and on a value attributed to the conversion based at least partly on properties of at least one interaction of the sequence.

Optionally, performance assessment module 235 may be configured to compute the performance assessment based on properties relating to at least one interaction out of the sequence of interactions, wherein the properties include at least one property value which may be unrelated to the order of the interactions in the sequence.

Optionally, performance assessment module 235 may be configured to compute the performance assessment based on properties relating to at least one interaction out of the sequence of interactions, wherein the properties include at least one property value which may be unrelated to a time in which any of the interactions occurred (and may be therefore unrelated to order of the interactions in the sequence as well).

Optionally, performance assessment module 235 may be configured to compute the performance assessment based on properties of at least one subset of interactions of the sequence, wherein the subset includes multiple interactions.

It may be noted that any of the types of properties and patterns discussed herein may also be used by system 200, and especially, that performance assessment module 235 may be configured to implement any combination of one or more of these properties and patterns.

System 200 may also be configured to implement method herein, in which case interface 210 may be used to obtain the sequence referred to as “the original sequence”. Processor 220 (either by executing the program code of module 235 or by another dedicated module) in such a case may be configured to define multiple possible future interactions which may occur after the original sequence of interactions, based on the obtained information (the multiple possible future interactions defined need not include some future interactions, but rather several interactions). This selection of the possible future interactions may be based on the properties of the interactions in the original sequence, on patterns within the original sequence, and possibly on additional data (e.g. data regarding the user, data regarding an advertisement campaign, data regarding costs of such possible future interactions, etc.).

Processor 220 in such a case may be also configured to manage, based on the obtained information and on the multiple possible future interactions, acquisition of information of interactions for each out of a plurality of hypothetical sequence of interactions (this acquisition may involve communication over interface 210). Each of the hypothetical sequence of interactions includes the original sequence of interactions followed by one or more of the possible future interactions.

Performance assessment module 235 may then compute a performance assessment for each out of these multiple hypothetical sequence, and the program code of a selection module executed by processor 220 (not illustrated) may then select one or more out of the possible future interactions based on the performance assessment computed for different hypothetical sequence, and possibly on additional data (e.g. estimated cost of implementing the different alternatives). For example, if the performance assessment of hypothetical sequence A may be 1% larger than that of hypothetical sequence B, but the cost of executing the future interactions included in hypothetical sequence A may be 10% larger, the future interactions of hypothetical sequence B may be selected. This selection facilitates executing the selected future interactions.

Optionally, the program code of evaluation module 240 may be implemented on processor 220, attribution module 230 configured to determine the value of the sequence of interactions. Optionally, the value may be based on a value of a conversion which ends the sequence of interactions. Optionally, a group of value-sources, on which the value may be based, excludes any value of a sequence closing conversion.

Optionally, a grouping module 250 may be implemented on the processor, the grouping module may be configured to divide interactions of the sequence into multiple groups of interactions, the dividing may be based on the properties of interactions of the sequence; wherein attribution module 230 may be configured to attribute at least one of the apportionments of the value to the respective interaction of the sequence, based on a group to which that interaction was grouped.

Optionally, grouping module 250 may be configured to divide interactions into the groups based on properties quantifying relative quality of the interactions. Optionally, grouping module 250 may be configured to divide interactions into the groups based on types of advertisement channels used by the respective interactions.

Optionally, grouping module 250 may be configured to divide interactions into the groups based on properties of at least one subset of interactions of the sequence, wherein the subset includes multiple interactions.

Optionally, grouping module 250 may be configured to divide interactions into the groups based on a pattern occurring in at least one property value of the interactions across the sequence of interactions.

Optionally, the program code of grouping module 250 may be executed by processor 220, where grouping module 250 may be configured to divide interactions of the sequence into multiple groups of interactions, such as a pattern, the dividing may be based on the properties of interactions of the sequence. Attribution module 230 may be configured to attribute one or more of the apportionments of the value to the respective interaction(s) of the sequence, based on a group to which that interaction may be classified.

Optionally, grouping module 250 may be configured to divide interactions into the groups in an iterative process that comprises subdividing interactions of a group into multiple subgroups of interactions, wherein the dividing may be based at least partly on attributes of the interactions of the sequence. Attribution module 230 may be configured to attribute the apportionments of the value in an iterative process that comprises attributing values to interactions of a subgroup based on a value assigned to a group in which the subgroup may be contained.

Optionally, grouping module 250 may be configured to divide interactions into the groups based on properties of at least one user participating in interactions of the sequence. The computing would include computing the performance assessment for the sequence of interactions associated with the selected user, that computing being based on the obtained information with respect to a specific user and on the assessment scheme.

Optionally, grouping module 250 may be configured to divide interactions into the groups based on properties of elements that triggered interactions of the sequence.

Optionally, grouping module 250 may be configured to divide interactions into the groups based on properties which pertain to an advertised entity associated with one or more interactions of the sequence of interactions. Optionally, grouping module 250 may be configured to divide interactions into the groups based on properties of at least one keyword entered by a user which triggered at least one interaction of the sequence.

Optionally, grouping module 250 may be configured to divide interactions into the groups based on properties which pertain to an advertisement provided to a user in at least one of the interactions of the sequence.

Optionally, the computing may be based on properties relating to at least one interaction out of the sequence of interactions, wherein the properties include properties of at least one subset of interactions of the sequence (the subset includes multiple interactions) and at least one property value out of the following types: (a) properties quantifying relative quality of the interactions, and (b) types of advertisement channels used by the respective interactions.

Optionally, the program code of weight determination module 260 may be executed by processor 220.

Optionally, weight determination module 260 may be configured to determine a weight for each property value out of a plurality of properties of sets of interactions, wherein the determining of the weight may be based on frequencies of patterns of interactions having the properties.

Optionally, weight determination module 260 may be configured to determine a weight for each property value out of a plurality of properties of sets of interactions, wherein the determining of the weight may be based on relative success of sets of interactions which possess a similar property value with respect to success of other sets of interactions.

Optionally, weight determination module 260 may be configured to repeatedly update the calibrated assessment scheme (at regular intervals or otherwise), wherein each updating may be based on historical data which may be more recent than any of the previous instances of updating (that is, at least some of the historical data on which such updating may be based is more recent than any of the previous instances of updating).

Optionally, weight determination module 260 may be configured to determine a weight for each property value out of a plurality of properties of sets of interactions, wherein the determining of the weight may be based on relative success of sets of interactions which possess the property value with respect to success of other sets of interactions.

Optionally, weight determination module 260 may be configured to repeatedly update the calibrated attribution scheme (in regular intervals or otherwise), wherein each updating may be based on historical data which may be more recent than any of the previous instances of updating (that is, at least some of the historical data on which such updating may be based is more recent than any of the previous instances of updating).

Optionally, system 200 may include assessment scheme processing module 265 which may be configured to statistically analyze the historical data of the plurality of sequence of interactions, and to determine the assessment scheme based on a result of the analyzing.

Optionally, performance assessment module 235 may be configured to compute the performance analysis based on properties relating to at least one interaction out of the sequence of interactions, and the statistical analysis of assessment scheme processing module 265 may be based on frequencies of patterns of interactions having the properties.

Optionally, the statistical analysis of assessment scheme processing module 265 may be based on relative success of sets of interactions having certain patterns of interactions with respect to success of other sets of interactions having other patterns of interactions.

Optionally, system 200 enables an efficient utilization of resources (as discussed with respect to methods described herein). For example, system 200 may enable efficient utilization of communication resources, at least by reducing an amount of data communicated to the user, thereby reducing an amount of communication resources.

Optionally, assessment scheme processing module 265 may be configured to repeatedly update the calibrated assessment scheme (at regular intervals or otherwise), wherein each updating may be based on historical data which may be more recent than any of the previous instances of updating (that is, at least some of the historical data on which such updating may be based is more recent than any of the previous instances of updating).

Input interaction record data may be received from multiple sources. For example, logfiles comprising web server access requests from client terminals may be received from an ad server platform, a social network platform, a shopping platform, and/or the like. For example, data relating to conversions is received from purchasing web platforms, shopping platforms, and/or the like. For example, cookies and associated data from multiple clients is received from a server, platform, and/or the like, where each cookie and/or associated data may contain a user identification and/or indetifier, at least part of an interaction, a time stamp, and the like. For example, interaction data of a user sharing a review article on a television on a social media site may be stored in a logfile of the social media platform, and the interaction data may include a cookie from the user client terminal web browser, a timestamp the sharing was performed, a sharing request data indicating if the review was shared privately, with friends, publicly, and the like.

These logfiles, data, cookies, and/or the like, contain information that links between interactions or parts of an interaction, and by comparing the userids, cookie values, timestamps, associated data, and/or the like, the interactions may be determined, and sequences of interactions may be linked together based on the timestamps and userids. For example, a first user sharing a smartphone comparison to privately to a second user, and the second user completing a conversion, would link the second user conversion to the first user viewing the comparison. For example, a user searching on google for using a search string of “best smartphone recommendations”, then viewing a comparison of smartphones, searching for a specific smartphone price comparison, then posting on a social platform a request for recommendations of the specific smartphone, receiving a second user recommendation based on a purchase by the second user of the specific smartphone, the first user being presented an advertisement, the first user clicking on the advertisement and completing a conversion would link these interaction together, thereby allowing attribution of a conversion value to at least two of these interaction, such as 20% to the first search, 30% to the recommendation, and 50% to the advertisement.

Different types of interactions may be included in different sequences, at least some of the interactions are associated with one or more users. Interactions with users may be referred to as “user interactions”. An interaction may be part of a sequence as well as to an optional interaction, such as an outcome interaction.

Generally, among the types of user interactions which may be included in the sequence may be any engagements of a user with any digitally represented media (e.g., software, application, digital display), which contains or associates (links) to an advertiser's brand, content and products.

For simplicity of explanation, only a few types of interactions with a user are illustrated, and discussed further in the examples. Interactions may include:
Clicking by the user on an advertisement presented to him after searching a search engine (such as a Google® search engine);
Clicking by the user on an advertisement presented to him at a social network, for example based on user demographics and other characteristics, such as a Facebook® web site;
Conversions, for example purchase of a product by the user, signing-in to a website or a service, and the like;
Social network interactions, for example “liking” or sharing, by a user, of an advertisement, a product, a marketing page, for example on a Facebook® web site, a Twitter® web site, and the like;
E-mail sent to the user, for example an email triggered by the marketer or by another user;
and/or the like.

For example, types of interactions include: exposure to an advertisement without clicking it (impressions) in social networks or elsewhere; clicking on a link to a web site that appears on another's user social network page (also known as ‘news feed’ or ‘wall’ on Facebook®); check-ins at a geographical location, place of business, and/or the like, (i.e., proved digital notification of his current location) using a location-based social networking website for mobile devices (e.g., Foursquare®); clicking on a display advertisement (e.g., a banner), viewing an advertisement, playing a promotional video, clicking a link on a website such as YouTube™, fan event, and the like.

Each of the interactions may be associated with information regarding the interaction itself, and/or information pertaining to associated interactions, events, entities, and so on. Clearly, the information associated with each of the interactions may depend on the type of interactions.

Such information may pertain, for example, to any one or more of the following: type of the interaction, information transmitted during the interaction, length of the interaction, estimated value of the interaction, identity of one or more participants of the interaction, information regarding to more or more of the participants of the interaction, historic events which triggered the interaction, historic event which preceded the interaction, actions included in the interaction, and/or the like.

Each of FIGS. 2A through 2E illustrates various sequences of interactions. Some such sequences of interactions may be also occasionally referred to as “paths” and may also be referred to as “path to conversion” (P2C), or as “conversion funnel”. The performance assessment computed for a sequence may be a likelihood that the sequence would ultimately (or within a time T) lead to a conversion, and therefore the sequence may optionally not include any conversion. Since a sequence which includes a conversion (and even a sequence that ends with a conversion) may lead to another conversion (e.g. purchase of another item), a likelihood that the sequence would lead to a conversion may be computed for sequence which includes another conversion.

Reference is now made to FIG. 2A, which shows a schematic illustration of first example sequence 110 of interactions. A first interaction 111 in sequence 110 may be a search for a keyword, such as “smartphone”, on a search engine web site. A second interaction 112 in sequence 110 may be the receipt of user demographics from a social media web site, and a third interaction 113 may be a search for a specific smartphone “XYZ”. This sequence may lead to an optional fourth interaction 191, such as a purchase of an “XYZ” smartphone. The likelihood of optional fourth interaction 191 occurring may be estimated when computing the performance assessment. In the illustrated example, optional fourth interaction 191 may be a conversion outcome associated with the total value for the sequence. When computing the performance assessment, the optional fourth interaction 191 may have not yet occurred (and may never occur).

Reference is now made to FIG. 2B, which shows a schematic illustration of second example sequence 150 of interactions. A first interaction 151 in sequence 150 may be a search for a keyword, such as “smartphone”, on a search engine web site. A second interaction 152 in sequence 150 may be the presentation to the user on a social media web site of a smartphone ad, such as an “XYZ” smartphone ad from a specific seller. The smartphone ad may redirect to the seller's web site, such as a purchasing web site. User demographics may also be used in presenting the ad, selecting the ad, and the like. A third interaction 153 may be a search for a specific smartphone “XYZ” leading to a fourth interaction 154 of presenting an ad to purchase an accessory, such as a cover for smartphone “XYZ”, from the same specific seller, a different seller, and the like. When computing the performance assessment, the fourth interaction, such as an outcome interaction, may have not yet occurred.

Reference is now made to FIG. 2C, which shows a schematic illustration of third example sequence 120 of interactions. A first interaction 121 in sequence 120 may be a search for a keyword, such as “smartphone”, on a search engine web site. A second interaction 122 in sequence 120 may be the presentation of a smartphone ad to the user on a social media web site, such as an “XYZ” smartphone ad from a specific seller. The smartphone ad may redirect to the seller's web site, such as a purchasing web site. User demographics may also be used in presenting the ad, selecting the ad, and the like. A third interaction 123 may be a search for a specific smartphone “XYZ” on a search engine web site. A fourth interaction 124 may be the purchase of a smartphone, such as an “XYZ” smartphone, leading to a fifth interaction 125 of presenting an ad to purchase an accessory, such as a cover for smartphone “XYZ”, from the same specific seller, a different seller, and the like. When computing the performance assessment, a sixth interaction 192, such as an outcome interaction, may be the purchase of an “XYZ” smartphone cover from the advertised seller.

Reference is now made to FIG. 2D, which shows a schematic illustration of fourth example sequence 140 of interactions. A first interaction 141 in sequence 140 may be a search for a keyword, such as “smartphone”, on a search engine web site. A second interaction 142 in sequence 140 may be the presentation to the user on a social media web site of multiple smartphone ads from a specific seller. The smartphone ads may redirect to the seller's web site, such as a purchasing web site. User demographics may also be used in presenting the ads, selecting the ads, and the like. A third interaction 143 may be a search for a specific smartphone “XYZ” on a search engine web site. A fourth interaction 144 may be the purchase of a smartphone, such as an “XYZ” smartphone, leading to an optional fifth interaction 145, such as an outcome interaction, of presenting an ad to purchase an accessory, such as a cover for smartphone “XYZ”, from the same specific seller, a different seller, and the like.

Reference is now made to FIG. 2E, which shows a schematic illustration of fifth example sequence 130 of interactions. Sequence 130 may be a sequence of interactions involving two users, user A and user B, and may be referred to as a social engagement graph which may be regarded as multiple interconnected sequences of interactions. A first interaction 131 in sequence 130 may be a search by user A for a keyword, such as “smartphone”, on a search engine web site. A second interaction 132 in sequence 130 may be the presentation to user A on a social media web site of multiple smartphone ads from a specific seller. The smartphone ads may redirect to the seller's web site, such as a purchasing web site. User A demographics may also be used in presenting the ads, selecting the ads, and the like. A third interaction 133 may be a search by user A for a specific smartphone “XYZ” on a search engine web site. A fourth interaction 134 may be the purchase by user A of a smartphone, such as an “XYZ” smartphone, and a fifth interaction 135 of user A selecting a like button on a social media web site, a seller's web site, a product review web site, and the like. A sixth interaction 136 may be user A fifth interaction 135 with user B, such as by electronic mail, sharing on a social media web site, and the like. User B may perform a seventh interaction 137 of searching for a cover for smartphone “XYZ” on a search engine web site, leading to an optional purchase interaction 193 by user B of a cover for smartphone “XYZ” as a gift for user A.

Reference is now made to FIG. 2F, which shows a schematic illustration of a first example attribution of values to interactions in sequence 120 of FIG. 2C. A value for an outcome interaction 192 may be split into two values, a first value 181 for interactions 121, 122, 123, and 125, and a second value 182 for interaction 124. First value 181 may be further split into two sub-values, a first sub-value 181B for interactions 121 and 123, and a second sub-value 181A for interactions 122 and 125.

Reference is now made to FIG. 2G, which shows a schematic illustration of a second example attribution of values to interactions in sequence 120 of FIG. 2C. A value for sequence 120 may be split into two values, a first value 183 for interactions 121, 122, 123, and 124, and a second value 184 for interactions 125 and 192. First value 183 may be further split into two sub-values, a first sub-value 183A for interaction 124, and a second sub-value 183B for interactions 121, 122 and 123. Second sub-value 183B may be further split into first sub-sub-value 183B1 for interactions 121 and 123, and second sub-sub-value 183B2 for interaction 122. Second value 184 may be split into first sub-value 184A for interaction 125 and second sub-value 184A for interaction 192.

In FIGS. 2A through 2F the arrows may not indicate a causal relationship between the interactions, even though such relationships may occur. Arrows may represent an order of the interactions in the respective sequence.

The sequence of interactions, denoted S, may be a totally ordered set of interactions (i.e., fulfilling the conditions of Reflexivity {a≦a for all interactions aεS}; Antisymmetry {a≦b and b≦a implies a=b}; Transitivity {a≦b and b≦c implies a≦c}; and Comparability {for any pair of interactions of the sequence a,bεS, either a≦b or b≦a}. The order may be a temporal order.

For any adjacent pair of interaction in the sequence, the same user ID may be associated with both elements of the pair. For example, when a user interaction contains a first user sharing a digital media with a second user, the previous user interaction may be associated with the first user and the subsequent user interaction associated with the second user.

The sequence may not be partially or totally an ordered set of interactions. For example, some implementations may use a sequence which is a partially ordered set. For example, a set with the conditions of Reflexivity, Antisymmetry, and Transitivity, but not the condition of Comparability. In yet additional implementations, the sequence may be used to comply with some of the conditions for a partially ordered set.

Reference is now made to FIG. 3, which shows a flowchart of a first example computerized method 300 for attribution of values to interactions in sequences. Method 300 for attribution of values to interactions in a sequence may be used for example, to enable efficient utilization of various communication resources, such as advertising resources, communication hardware resources, advertisement channel resources, and the like. Method 300 may be carried out by system 200 of FIG. 1, such as by one or more processing modules thereof executed by at least one hardware processor.

Step 301 of method 300 may include obtaining information of interactions of a sequence. The information obtained in step 301 may pertain to all of the interactions of the sequence, or to some of the interactions. It may be assumed that the sequence includes interactions for which information may be obtained, and an original sequence may be used to define a sequence that includes interactions for which information may be obtained.

Step 301 of obtaining information may include obtaining information pertaining to the individual interactions, and may also include obtaining information pertaining to groups of interactions (either the entire sequence or parts thereof). For example, information pertaining to groups of interactions may include statistics regarding the interactions (e.g., the amount of social media interactions, total time spent by the user in a website of the marketer during the interactions, average time between interactions, total number of interactions, time from first interaction to conversion and/or the like).

Step 301 may include generating some or all of the information obtained, such as interaction records, receiving some or all of the information obtained, and/or selecting some or all of the information obtained out of larger database.

Method 300 may also include (e.g., as part of step 301) defining the sequence of interactions. For example, such a step of defining may include selecting a group of sequence out of a larger database of interactions. The defining of the sequence may include selecting a group which includes the interactions that comply to one or more selection criteria, such as interactions with a group of one or more identified users, interactions occurring within a predefined time frame, interactions over a group of one or more preselected advertising channels, interactions pertaining to a subgroup of advertised products but not to others, and/or the like.

Method 300 may also include optional step 302 of assigning the value to the sequence of user interactions. For example, step 302 may be carried out by a tracking processor which processes interaction and conversion events including properties of those interactions and conversions which may be provided by a web proxy or a report. For example, the tracking processor may update the value of the path each time a conversion or interaction event is received.

Alternatively, step 302 may be replaced with a step of receiving the value of the sequence, such as the value of a desired outcome of the sequence.

The assigning of the value may be at least partly based on input of a person (e.g., the advertiser, the e-shop owner, and the like), but may also be carried out entirely automatically. The assigning of the value may be based on value estimations of one or more conversions of the sequence (if any) and/or on value estimations of one or more conversions external to the sequence (e.g., preceding the interactions of the sequence of following those). Other sources of value estimation may pertain to the interactions themselves (e.g., types of interactions in the sequence), to one or more users associated with in any of the interactions of the sequence (e.g., some users may be valued higher than other users), and/or the like.

Optionally, the value of the sequence may be determined based on a value of a conversion which ends the sequence of interactions. The value of the conversion may be based on a price of a product or service purchased by the user, and may also be based on additional parameters. The value of such a conversion may not be the sole basis for the determination of the value.

Like in a sequence-closing conversion, the value of the conversion may be based on a price of a product or service purchased by the user, and may also be based on additional parameters. Various ways of evaluating conversions may be practiced as part of step 302. The value of such a conversion may not be the sole basis for the determination of the value.

Other parameters may be used in the determining of the value of the sequence, such as parameters not related to conversions. Optionally, the determining of the value to be assigned to the sequence may be based on a group of value-sources which excludes any value of a sequence-closing conversion, and possibly of other conversions as well.

Examples of parameters which may be used for evaluating the value of the sequence which may be unrelated to conversions may be “potential to convert” and the expected value of the potential conversion.

Method 300 continues with step 303 of attributing an apportionment of the value to each out of a plurality of interactions of the sequence, based on properties relating to at least one interaction out of the sequence of interactions. Optionally, step 303 may include attributing the respective apportionment of the value to each out of the plurality of interactions of the sequence, based on a calibrated attribution scheme and on the properties relating to the at least one interaction out of the sequence of interactions.

Optionally, the group of properties, on which the attributing of step 303 may be based, includes at least one property value which may be unrelated to a time in which any of the interactions occurred. Specifically, at least one of the properties may be not related to any of the following:
a. a time in which any of the interactions occurred;
b. time passed between any two of more of the interactions of the sequence;
c. time passed between any of the interactions to another event or point in time;
d. relation of order between any two or more of the interactions of the sequence.

Some of the properties of the interactions of step 303 may be related to time between interactions (e.g., in addition to other properties such as the type of channel over which one or more of the interactions occurred).

Referring to the examples set forth with respect to the drawings, step 303 may be carried out by an attribution module such as attribution module 230 of FIG. 1. The attributing of step 303 may be based on various types of properties—each pertaining to one or more interactions. Additionally, the attributing of step 303 may be based on additional information other than the properties which relate to the one or more interactions.

The interactions-related properties, on which the attributing of step 303 may be based, do not pertain to the order of the interactions within the sequence. The attributing may be rather based on properties of the interactions such as (although not limited to) any combination of the following types of properties:
a. properties quantifying relative quality of the interaction, of types of communication or of advertisement channels used by the respective interaction;
b. properties of at least one subset of interactions of the sequence, the subset including multiple interactions (such as combinations). For example, ordered or unordered sequences, types of interactions, amount of interactions of a given type in the entire sequence, temporal relations between interactions, temporal relations between interactions of predefined types, and the like;
c. properties of elements that triggered interactions of the sequence. For example, of a keyword in an interaction that involves keywords, the length of that keyword, whether such keyword includes or otherwise pertains to a pre-identified commercial brand or other advertised entity or not, and the like.
By way of example, such keywords may indicate a type or classification of the conducted search (which involved the keywords). Such typing may refer to the scope of the search (whether this search was relatively broad/generic, e.g., a search for “cellular phone” relatively narrow/specific, e.g., a search for “Samsung® Galaxy® S3”). Another typing may pertain to the assumed purpose of the search (e.g., resembling a search in an index, for finding a known website, or for finding previously unknown information; navigational/non-navigational search);
d. properties which pertain to the creative media used in an advertisement involved in at least one of the respective interactions (e.g., copy, size, content, images, videos);
e. properties which pertain to an advertised entity associated with the interaction (e.g., properties pertaining to a commercial company, a brand, a product, a service, and/or the like);
f. properties which pertain to an advertisement provided to a user in the interaction;
g. properties which pertain to an estimated phase of a process-to-conversion model to which the interaction belongs (e.g., attention; interest; desire; action);
h. properties of the sequence of interactions which pertain to the order in which interactions of different types may be ordered;
i. properties of the sequence of interactions which pertain to elapsed time between the interactions and between the interactions and conversions;
j. properties of the user, i.e., the ‘interactor’ (e.g., its personal characteristics, its location and/or the like);
k. properties of the platform used for the interaction (e.g., a mobile device, a desktop and/or the like)

The attributing of the apportionments of the value to the respective interactions of the plurality of interactions may be used for different uses, in different embodiments. Possibly, the attributing of step 303 may enable efficient utilization of communication resources, and/or of other types of resources. This efficient utilization of resources (and especially of the communication resources) may be part of method 300. Such communication resources may include, for example, any combination of one or more of the following: advertising resources, communication hardware resources, advertisement channel resources, and so on).

The calibrated attribution scheme, on which the attributing of step 303 may optionally be based, may be implemented in different ways. An attribution scheme may be a set of one or more rules according to which apportionments of the values may be attributed to each out of the plurality of interactions of the sequence. Some attribution schemes which may be implemented may include simple rules (e.g., “evenly attribute 60% of the value between interactions associated with a brand related keyword and evenly attribute 40% of the value between the other interactions), while other possible attribution schemes may include substantially more complex rules (e.g., as discussed with respect to FIG. 2A to 2F). While some attribution schemes may be strictly deterministic, other may include some random or semi-random aspects.

An attribution scheme may be determined by an expert, regardless of any specific statistical data, or based on (solely or partly) on statistics of historical interactions logs. An example of the former may be order-based attribution-scheme in which 40% of the value may be attributed to the first interaction of the sequence while 20%, 20%, and 40% may be attributed to the second, third and fourth interactions respectively in a 4-interactions sequence.

A calibrated attribution scheme may be an attribution scheme which may be based on an analysis (e.g., a statistical analysis, possibly also linguistic analysis, and/or the like) of historical data which includes multiple sequence of interactions. Optionally, the historical data may be analyzed for the generation of the calibrated attribution scheme may also include the ways in which the values of some or all of these sequence were attributed. The calibrated attribution scheme may be calibrated using a sequence of interactions which fulfill a selection condition, and may use a sequence of interactions which fulfill the same selection condition.

For example, the following calibrated attribution schemes pertain only to sequence of interactions which fulfill the following conditions:
a. sequence of interactions which may be associated with a certain advertiser.
b. sequence of interactions which may be associated with a certain country or jurisdiction.
c. sequence of interactions which may be associated with a certain line of products of a given advertiser.
d. sequence of interactions which may be associated with a certain vertical.

Furthermore, the calibrated attribution scheme may be an attribution scheme may be based on an analysis of partial historical data (i.e., not all of the available historical data) may be selected out of a larger log of historical data based on compliance of the selected sequence (and/or interactions) with one or more such selection rules.

For example, a log of historical data which pertains to a single advertiser may be divided based on the line of product (e.g., cellular phones vs. televisions), and each of these parts may be used for the generation of a respective calibrated attribution scheme. Afterwards, a value of a sequence of interactions may be associated with televisions (e.g., a conversion in which a television was purchased online) would be attributed based on the attribution scheme calibrated based on the television-related historical data, while a value of a sequence of interactions may be associated with cellular phones (e.g., a conversion in which a charger for an iPhone® cellular phone was purchased online) would be attributed based on the attribution scheme calibrated based on the cellular-phones-related historical data.

The calibrated attribution scheme may be updated from time to time based on new historical data. That is, method 300 may further include repeatedly updating the calibrated attribution scheme (in regular intervals or otherwise), wherein each updating may be based on historical data may be more recent than any of the previous instances of updating (that is, at least some of the historical data, on which such updating may be based, is more recent than any of the previous instances of updating).

Method 300 may be used for building and utilizing a calibrated attribution scheme that may be unique to an advertiser, for attributing values to individual interactions in a sequence of user interactions. Such method would include executing by a processor: (a) analyzing historical data of a plurality of sequence of interactions with a plurality of users, each of the plurality of sequence including at least one interaction may be associated with the advertiser; (b) determining the calibrated attribution scheme based on results of the analyzing (e.g., by determining weights such as in step 570 of FIG. 5); and (c) attributing a value associated with a sequence of user interactions, at least one may be associated with the advertiser, to individual interactions in the sequence according to the previously discussed steps of method 300.

The analysis of the historical data may reflect, for example, causal relationship between interactions (interactions causing other interactions) and causal relationship between interactions and conversions. The analysis may include analysis of sequence which did not contain conversions.

Method 300 may include step 304 of updating a database entry based on the apportionment of the value attributed to one or more out of the plurality of interactions. Referring to the examples set forth with respect to the previous drawings, step 304 may be carried out by a database such as database 270 of FIG. 1, or by a database management module (not illustrated) implemented on a processor such as processor 220 of FIG. 1. The updating may include a step of processing one or more of the apportionments (and possibly additional data) to determine the new value for the database entry.

The updating of step 304 may include updating a database entry associated with one of the plurality of interactions, based on the apportionment of the value attributed to that interaction, a process which may be repeated for more than one interaction out of the plurality of interactions. The updating of step 304 may also include updating a database entry that may be associated with one or more properties of interactions (e.g., the type of interaction) based on the apportionment of the value attributed to one of more out of the plurality of interactions.

For example, the updating may include updating assessments of a potential contribution of a type of interaction to the realization of a future event. For example, one or more of the following entry types may be updated, pertaining to one or more interactions types:
An assessment of the likelihood that an interaction of the respective interaction type would lead to a conversion;
An assessment of the likelihood that an interaction of the respective interaction type would lead to an interaction of another type (e.g., the likelihood that a search-engine originated interaction would lead to a social-network based interaction).

Optionally, step 304 may also include updating entry which pertain to a sequence of interactions, or to a sequence of interaction types. For example, one or more of the following entry types may be updated, pertaining to a sequence of interactions of one or more interactions types:
An assessment of the likelihood that a sequence of interactions of one or more interactions types (e.g., an Interaction pertaining to advertiser's brand followed by two interactions which do not pertain to that brand; three interactions within one hours, and/or the like) would lead to a conversion.
An assessment of the likelihood that a pattern occurring in at least one property value of the interactions across a subgroup of some or all of the interactions of the sequence which may be of one or more interactions types (e.g., an Interaction pertaining to advertiser's brand followed by two interactions which do not pertain to that brand; three interactions within one hours, and/or the like) would lead to a conversion
An assessment of the likelihood that that a sequence of interactions of one or more interactions types would lead to an interaction of a known type.

One interaction may lead to another and that this other interaction may lead to a conversion. For example, an interest aroused in the client by a display ad may lead the customer to later search for the advertiser's site using a search engine. In other scenarios, two interactions in a sequence may be completely unconnected. Step 304 may be implemented for detecting and/or for reflecting whether there may be a causal relationship between interactions (or interaction types), and in cases where such causality does exist assign credit to both indirect and direct players in the conversion path.

Optionally, method 300 may include statistically analyzing historical data of a plurality of sequence of interactions with at least one user for detecting one or more causal relationships between different interactions types. For example, when an occurrence of one or more of interactions type indicates high likelihood that interaction of another one of these interaction types would occur. For example, value assignment may be done based on an analysis of the historical data, and assigning credit to both direct and indirect interactions in the sequence based on the causal relationship (i.e., to interactions contributing to the conversion directly and to interactions contributing to the conversion indirectly).

In addition to causality, the updating of step 304 may also be implemented for detecting and/or reflecting synergy. A customer looking to buy a television may be influenced by the paid search ads that appear and that they clicked on while searching for a specific model using a search engine. They could also be influenced by seeing an ad on a social networking site such as Facebook® that reports that one or more of their friends “likes” a certain online electronics store. But the combined influence of seeing the same store come up in both the paid search ads and on Facebook® may be larger than the influence of each of those individual engagements. The updated entries may later be used so that such synergies may be detected and so that credit would be attributed appropriately when they occur.

Optionally, method 300 may include statistically analyzing historical data of a plurality of sequence of interactions with a plurality of users for detecting synergy between different types of interactions, wherein the attributing of the value may be based on the detected synergy. The detecting of such synergy may be a part of the statistical analysis which serves for the determination/updating of the calibrated attribution module (if implemented), and the utilizing of the synergy in the attributing may in such case be a result of utilizing the calibrated attribution scheme which reflects the detected synergy. The detection of the synergy may be explicit or implicit (i.e., the method may include detecting such synergy even if such synergy may not be explicitly pointed out as “synergy”).

Method 300 may also include step 305 of communicating with one or more users, based on a result of the attributing of the apportionments to the plurality of interactions. Referring to the examples set forth with respect to the previous drawings, step 305 may be carried out by a communication module such as communication module 280 of FIG. 1. The communicating of step 305 may include providing advertisements to the one or more users, or providing other information, and may also include receiving information from such one or more users.

The efficient utilization of communication or advertising resources (e.g., as part of step 305) may be a result of utilizing the aforementioned database for future communication with the client, and especially using one of the entries updated at optional step 304, based on the attribution of step 303.

For example, the efficient utilization of communication resources (which may include advertising resources, communication hardware resources, advertisement channel resources, and so on), enabled by the attributing of step 303 may include reducing an amount of data communicated to the user, thereby reducing an amount of communication resources. For example, parameters of the user, and/or of a posterior possible interaction with the user may be analyzed based on the results of the attribution (e.g., based on the database referred to in the context of step 304). If a result of the analysis may be a given interaction with the user at that opportunity should be limited or altogether avoided, a clear reduction in communication costs (financial, datalink, processing power, and/or the like) may be obtained.

Efficient utilization of communication or advertising resources may also be achieved by better targeting the user with targeted advertising in view of the results of the attribution (e.g., based on the database referred to in the context of step 304).

Another example of utilization of advertising resources may be changing elements which may be involved in an interaction, as changing a keyword which involved in a search engine marketing (SEM) campaign in view of the results of the attribution. Yet another example of utilization, may be changing inputs to other mechanisms and systems that interact or otherwise connect to the interaction, as changing the bid value with respect to keywords that may be involved in a search engine marketing (SEM) campaign in view of the results of the attribution. Other examples, include changing bid values in real time and the like.

In addition to regular uses of the term “efficiency” and its derivative forms (e.g., “efficiently”) as used herein should be expansively construed to cover ways of putting the relevant resources into good, thorough, and/or careful use, especially regarding the utilization of these resources (thereby consuming a relatively small amount of such resources for providing a desirable outcome).

Reverting to step 303 and to the various kinds of properties which may be used in the process of attributing the apportionments of the value.

Optionally, the attributing may include attributing the apportionments of the value based on properties quantifying relative quality of the interactions. While different types of interactions (e.g., e-mails, telephone conversations, electronic advertisements, social media interactions, paper advertisements, videos watched, and/or the like) may be qualified by different types of quantities, many such quantified properties using for assessing quality of the interactions may be implemented. For example, such properties quantifying relative quality of the interactions may include:
a. Duration of the interaction (e.g., time spent on website, duration of a phone conversation, percent of video length watched by the user, and/or the like);
b. Amount of data transferred to the client during the interaction (e.g., amount of web pages viewed);
c. Engagement of the user in the interaction (e.g., view, mouse-over, click in, click out)

Such properties quantifying relative quality of the interactions may also quantify relative quality of a group of interactions (e.g., interactions of the same type). For example, statistic products of the example properties (e.g., minimum, maximum, average, median, mean, standard deviation, and/or the like). Other examples include:
a. Parameters qualifying response of user (or users) to such interactions (e.g., bounce rate);
b. Redundancy in interactions (e.g., times in which the interaction resulted from the same keyword entered by the user);

Optionally, the attributing may include attributing the apportionments of the value based on properties of at least one keyword entered by a user which triggered at least one interaction of the sequence.

Optionally, the attributing may include attributing the apportionments of the value based on properties which pertain to an advertisement provided to a user in at least one of the interactions of the sequence. Such properties pertaining to such an advertisement may be, for example, the type of the advertisement (e.g., video, non-video, image, animated-gif, text, and/or the like), duration of the advertisement, size of the advertisement (in centimeters, in pixels, and/or the like), an affectivity score of the advertisement (e.g., based on previous success/attribution analysis), its source (e.g., being sent from a friend, being included in a social-media feed, and/or the like), and so on.

Optionally, the attributing may include attributing the apportionments of the value based on types of advertisement channels used by the respective interactions. The types of communication may be analyzed in different resolutions. By way of example, a very coarse resolution may be machine interactions vs. human interactions. A finer resolution would be the interactions technology used (e.g., e-mail, video, text ad, social-media, telephone, billboard). A yet finer resolution would differentiate, for example, between video advertisements embedded in an external website to video streamed at the website of the publisher, contextual display advertising, paid/non-paid advertising, and so on.

Optionally, the attributing may include attributing the apportionments of the value based on properties of elements that triggered interactions of the sequence. Interactions may be triggered by actions of the user who may be a party of the interaction (e.g., by entering a keyword into a search engine), by the marketer (e.g., by sending a newsletter and/or an advertisement to a mailing list of users), or by actions of another user.

The properties pertaining to such elements (or events) may be, for example, parameters of the keyword entered (e.g., its length) or other element involved in the interaction, demographic parameters of a user (e.g., age, gender), and may also be meta-parameters such as—does the keyword include a brand-name of the marketer, does the keyword include a specific product name, manufacturer or model and/or the like. Parameters which pertain to the event which triggered the interactions may be time of the event (e.g., the time of the day in which the keyword was entered by the user), the location of the event, and/or the like. The event which triggered the interaction may be another interaction (which may be part of the sequence).

Optionally, the attributing may include attributing the apportionments of the value based on properties of at least one keyword entered by a user which triggered at least one interaction of the sequence.

Optionally, the attributing may include attributing the apportionments of the value based on properties which pertain to an advertised entity associated with one or more interactions of the sequence of interactions. The advertised entity may be the marketer itself (for example, such a property value is: whether the keyword includes the brand-name of the marketer), and may also be an advertised product or a service.

By way of example, the user may have ultimately purchased a certain type of product (say, a DELL® computer). In view of this light, advertisement which were presented to this user and which advertised totally unrelated products (e.g., shoes, razor blades, and/or the like) may be attributed smaller apportionments than advertisements (or other types of interactions) which may be more relevant to the advertised entity (e.g., ones pertaining to computers, electronic gadgets, other DELL® products, and/or the like).

Optionally, the attributing may include attributing the apportionments of the value based on properties of at least one subset of interactions of the sequence, wherein the subset includes multiple interactions. The subset of interaction may be defined in different ways.

For example, such properties of a subset of interactions may include:
a. Duration between two (or more) interactions of the subset;
b. Causal relations between two (or more) interactions of the subset;
c. Patterns occurring in at least one property value of the interactions across the subset of interactions (e.g., considering the property Brand (B) vs. Non-Conversion (NB) as a type of a single interaction, the property of the subset may be defined as whether the pattern NB-NB-NB-B occurs in the ordered subset);
d. The number of users that were a party to at least one of the interactions (and possibly the number of interactions having at least a predefined number of users participating therein);

The subset may be a proper subset of the sequence of interactions (i.e., include a smaller number of interactions), but in other alternatives it may include the entire sequence of interactions. Using the terminology of a path of interactions (also referred to as “conversion funnel”, “Path to conversion” or P2C, where applicable, or possibly also just as “Path”), the attributing may include attributing the apportionments of the value based on patterns occurring in at least one property of the interactions across the sequence of interactions, i.e., —across the path.

Reverting to step 305 which includes communicating with one or more users (possibly other users than the one or more which were parties to the interactions of the sequence). Information about such later communication may be obtained at a later reiteration of step 301, and the method may be repeated. Different steps of attribution may be based on different attribution logic and/or parameters; especially if those parameters and/or logic may be based on the result of the attribution (step 303) or of posterior communication (step 304), but also in other situations.

A single sequence of interactions may include interactions with more than one user (as in the example of FIG. 2C), and hence may be referred to as a social engagement graph. A sequence may also be regarded as multiple interconnected sequence of interactions. Optionally, the attributing of step 303 may include attributing values to interactions of multiple interconnected sequence of user interactions which may be associated with multiple users.

Reference is now made to FIG. 4, which is a shows a flowchart of a second example computerized method 400 for attribution of values to interactions in sequences. Steps 401 and 402 may be similar to steps 301 and 302 of FIG. 3, respectively.

Optionally, attributing step 405 may be preceded by a dividing of the interactions of the sequence into multiple groups of interactions (as in step 403), wherein the dividing may be based on the properties of interactions of the sequence. Like before, such properties may pertain to a single interaction (e.g., channel of the interaction, quality of the interaction, duration of the interaction, and/or the like), and also to a groups of interactions (whether consecutive groups based on the order of the interactions in the sequence, or inconsecutive groups deviating from any such order). Properties which pertain to a group of interactions may be, for example, related to a pattern within one or more properties of a single interaction, across the group.

The attributing of step 405 may include attributing at least one of the apportionments of the value to the respective interaction of the sequence, based on a group to which that interaction was grouped. For example, method 400 may include optional step 404 of attributing an apportionment of the value to each out of a plurality of groups of interactions, and based upon the apportionment attributed to each of the groups, further attribute that apportionment to interactions included in the group. The attribution of the apportionments to each of the groups may be based on properties by which the interactions where grouped to that group (e.g., based on the interaction channel, in groups include only interactions over a certain channel), and may also be based on other properties of the interactions of the group (continuing the same example, the same group may be attributed an apportionment based on the average duration of the interactions included in that group).

The attributing of step 405 may also be an iterative process that may include attributing values to interactions of a subgroup (and possibly to the subgroup itself) based on a value assigned to a group in which the subgroup may be contained.

Steps 406 and 407 may be similar to steps 304 and 305 of FIG. 3, respectively.

Following are examples of attributing values to interactions in a sequence.

For example, each of FIGS. 2F and 2G illustrates the sequence of FIG. 2C after being divided as in step 403, according to different dividing schemes. In the example of FIG. 2F, value 182 includes interactions which may be conversions, and value 181 includes interactions which may be not conversions.

Optionally, the dividing of step 403 may be implemented as an iterative process that includes subdividing interactions of a group of interactions into multiple subgroups of interactions (both the dividing and any instance of subdividing may be based at least partly on attributes of the interactions of the sequence, and especially on those of the group/subgroup).

Reverting to the example of FIG. 2F, value 181 may be divided into subgroup value 181A which includes interactions resulting from advertisement provided to a search engine user, based on keywords he entered, and to subgroup value 181B which includes interactions originating from social media activity.

Reverting to the example of FIG. 2G, an initial grouping step includes grouping the interactions of sequence 120 to groups which precede conversions, such as group values 183 and 184. A second step of sub-grouping includes differentiating between the conversion of each of those subgroups to the other interactions therein. In a third step of sub-grouping, group 183B (which may be a group including more than one interactions after the second step of sub-grouping) may be divided again based on the channel originating the interaction—subgroup 183B1 includes interactions resulting from advertisement provided to a search engine user, based on keywords he entered, and subgroup 183B2 includes an interaction originating from social media activity.

In an iterative implementation of the attributing of step 405 as applied to the groups of FIG. 2G, firstly a first apportionment of the value of sequence 120 may be attributed to group 184 and a second apportionment of the value may be attributed to group 183. The sum of the first apportionment and of the second apportionment may be equal in this example to the value of sequence 120.

At a second step, the first apportionment of the value (the one attributed to group 184) may be attributed in parts to subgroups 184A and 184AB, or directly to the corresponding interactions 125 and 192 (because there may be only one interaction in each of those subgroups). If the attribution in that step second may be not done directly to interactions 125 and 192, values may be attributed to them based on the corresponding parts of the first apportionment. Like before, the parts of the apportionment of the value attributed to the group (those parts which may be attributed to the subgroups) may sum to the apportionment of the value attributed to the group.

The second apportionment of the value (the one attributed to group 183) in turn may be attributed in parts to subgroups 183A and 183B. The part of the second apportionment which may be attributed to subgroup 183B may be further attributed in parts to the subgroup of yet lower hierarchy, subgroups 183B1 and 183B2. This attribution may be based, for example, on different weights which may be given to interactions originating with search engine activity and to interactions originating with social media activity. Possible techniques of determining such weights may be disclosed. Other weights (or other parameters) may also be used to determine other attributions to groups and subgroups.

The attribution of value to multiple interactions in a lowest hierarchy level subgroup (e.g., subgroup 183B1) may be implemented in different ways. For example, equal values may be attributed to each of those interactions, or attribution may be based on order or on other properties.

In an option exemplified in FIG. 2C, the dividing may include dividing interactions of the sequence into multiple groups of interactions based on the identify and/or the properties of at least one user participating in interactions of the sequence. For example, interactions may be divided into groups based on a distinction between new users to existing users. Naturally, a first interaction with a user may be included in a group of interactions with new users, while a later interaction with the very same user may be included in a group of interactions with existing users.

Any of the properties, such as determined in attribution of step 405, may be implemented may also serve as a basis for dividing into groups in step 403.

Optionally, the dividing may include dividing interactions of the sequence into multiple groups of interactions based on any one or more of the following:
a. Properties quantifying relative quality of the interactions;
b. Types of advertisement channels used by the respective interactions;
c. Properties of at least one subset of interactions of the sequence, wherein the subset includes multiple interactions;
d. Properties of elements and/or events that triggered interactions of the sequence;
e. Properties which pertain to an advertised entity associated with the interaction;
f. Properties of at least one keyword entered by a user which triggered at least one interaction of the sequence;
g. Properties which pertain to an advertisement provided to a user in at least one of the interactions of the sequence;
h. Patterns occurring in at least one property of the interactions across the sequence of interactions.

Reverting to the examples of FIG. 2G which exemplifies a grouping of the interactions of sequence (in the example, sequence 120) to groups which precede conversions. An occurrence of a conversion may trigger an attribution of a value which may be based at least in part on an evaluation of that conversion. That value may be attributed to interactions that belong to a sequence of interactions preceding the conversion (possibly including the conversion as well).

Referring to the example of FIG. 2G, an attributing of the value of conversion 124 (or a value which may be based on that value) to the interactions of group 183B may be carried out before attempting to attribute the value of sequence 120 to the interactions of that sequence. Assuming that the value of sequence 120 may be based on the value of conversion 192 in which a protective cover for a Samsung® Galaxy® SII Smartphone may be purchased, there may be a reason to attribute value also to the interactions preceding conversion 124, because the purchase of (or at least the interest in) the Smartphone may be likely to have contributed to the process which ended with purchasing that cover. That is, value which may be associated with a later conversion may be attributed to interactions which preceded (and lead) to a previous conversion of the sequence.

However, assuming that a relationship between the apportionment of the value of conversion 124 attributed to the various interactions of group 183B may be known (e.g., it may be a result of a previous execution of method 500), those relationships may be used to attribute any value attributed to the group including that conversion 124. For example, 60% of the value of sequence 120 may be attributed to the group of interactions including the very last conversion (group 184), and the remaining 40% may be distributed between the groups corresponding to the preceding conversions of the sequence (in this case only group 183B). The 40% attributed to group 183B may be attributed in parts to the interactions of group 183B based on the previously established relationships.

Therefore, method 400 may optionally include obtaining information indicative of relations between values previously attributed to interactions of a previously analyzed sequence of interactions (e.g., the sequence including the interactions of group 183B) that may be associated with a conversion (e.g., conversion 124) included in the sequence (e.g., sequence 120). The obtaining of that information may be part of step 401, may also be executed independently thereof.

The attributing of step 405 in such an implementation may include attributing values to interactions of the previously analyzed sequence (e.g., the sequence corresponding to group 183B, in this example), based on the aforementioned obtained relations, and on a value attributed to the conversion (or to the corresponding subgroup, e.g., conversion 124 or equivalently subgroup 183B in this example) based at least partly on properties of at least one interaction of the sequence (e.g., sequence 120 in this example).

Reverting to the dividing of the interactions into groups (exemplified in FIGS. 2F and 2G), whether implemented as an iterative process, or otherwise. The dividing of the interactions into groups may be based on a division scheme which may be determined with the help of the properties of at least some of the interactions (or subsets of interactions) of the sequence. for example, the division scheme may be a predetermined scheme, or a scheme whose parameters may be determined irrespective of the specific interactions included in the specific sequence.

The division scheme may include an order of properties by which the interactions of the sequence may be grouped. In the example of FIG. 2G, such order would be: 1. Groups pertaining to different conversions; 2. Subgroups containing the conversion vs. groups containing the rest of the interactions of the respective group; 3. Type of trigger of the interaction.

That division scheme may be determined by a human expert but may also be determined by a computer processor (e.g., based on statistics of many sequence of interactions). Further, the order of dividing the path into subgroups according to different dividing schemes may a pre-determined decision which can be based on past experience and statistics, or may be an output of a dynamic process.

Reference is now made to FIG. 5, which shows a flowchart of a third example computerized method 500 for attribution of values to interactions in sequences. In method 500 steps 510, 520, 530, 540, 550, and 560 may be similar and correspond to steps 401, 402, 403, 405, 406, and 407 of FIG. 4, respectively. The attribution of the apportionments of the value to the respective interactions in step 540 may be based, as aforementioned, on properties relating to at least one interaction out of the sequence of interactions. The attributing may be based, for example, on weights which may be given to different types of properties.

For example, it may be assumed that attribution of a value (whether that of the entire sequence or that attributed to a subgroup thereof) to interactions based on the number of users in each interaction may include attributing in parts 80% of that value to interactions that include only one user, and attributing in parts 20% of that value to interactions that include two users or more. While in the previous example the weights (80%, 20% in that example) may be predetermined values, such weights may also be determined, based on a statistical analysis.

Method 500 may include optional step 570 of determining weights based on a machine implemented statistical analysis of historical data of a plurality of sequence of interactions with a plurality of users. Referring to the examples set forth with respect to the previous drawings, step 570 may be carried out by a weight determination module such as weight determination module 260. The attributing of the values in step 540 may be based in such case on the weights which may be determined based on the statistical analysis of the historical data of the plurality of sequence of interactions with a plurality of users.

Step 570 may include, for example, determining a weight for each property out of a plurality of properties of sets of interactions, wherein the determining of the weight may be based on frequencies of patterns of interactions having the properties. Such sets may include sets including a single interaction each, and/or sets that include more than one interaction each.

Step 570 may also include, for example, determining a weight for each property out of a plurality of properties of sets of interactions, wherein the determining of the weight may be based on relative success of sets of interactions which possess the property with respect to success of other sets of interactions.

The properties may include, for example:
a. Properties quantifying relative quality of the interactions;
b. Types of advertisement channels used by the respective interactions;
c. Properties of at least one subset of interactions of the sequence, wherein the subset includes multiple interactions;
d. Properties of elements and/or events that triggered interactions of the sequence;
e. Properties which pertain to an advertised entity associated with the sequence of interactions;
f. Properties of at least one keyword entered by a user which triggered at least one interaction of the sequence;
g. Properties which pertain to an advertisement provided to a user in at least one of the interactions of the sequence;
h. Patterns occurring in at least one property of the interactions across the sequence of interactions.

Reference is now made to FIG. 6, which shows a flowchart of a fourth example computerized method 600 for attribution of values to interactions in sequences. Method 600 includes, among other steps, a step of computing a performance assessment for a sequence of interactions. The computing of the performance assessment may be a target of method 600, or a step used as a basis for other actions. For example, such computing of performance assessment may enable efficient utilization of various communication resources (which may include advertising resources, communication hardware resources, advertisement channel resources, and/or the like).

Referring to the examples set forth with respect to the previous drawings, method 600 may be carried out by a system such as system 200, and especially by one or more processing modules thereof (each implemented by at least one tangible hardware processor).

The sequence of user interactions (a few examples may be illustrated in FIGS. 2A through 2E) may include the interactions (for which data exists) with a single user (or with multiple users, especially of those which may be related to each other, e.g., via one of the interactions), but other grouping conditions may also be applied. For example, the sequence may be limited only to interactions which occurred within a predefined time frame, only to interactions over preselected channels, only to interactions pertaining to a subgroup of advertised products but not to others, and so on.

One example of a sequence of interactions may be a sequence of interactions which may optionally lead to a conversion (a path to conversion). For example, a conversion may be purchasing a product online, joining a mailing list, voting in a survey, “Like”-ing, “+1”-ing or “Tweet”-ing a page on a website, “Like”-ing a page on Facebook® and so on. The sequence of interactions may not include all of the interactions of the marketer with the user. Some interactions may be irrelevant, for example the user may have searched for several unrelated products but only some of these interactions may be relevant for an optional future purchase of a selected one of them. Some of the interactions may be unaccounted for, for example the user may have seen a billboard advertisement of the marketer, or have seen another person using the product.

While methods disclosed herein (and likewise system 200) may be exemplified in many of the examples with respect to Internet-based interactions and to advertising, they may not be limited to such implementations.

Other significant fields in which method 600 (and likewise system 200) may be implemented may be in production analysis in defect detection.

In production analysis, the production of any product (e.g., an engine, a car, an engineered quartz casting, an integrated circuit, and so on) may includes a sequence of interactions (e.g., heating for a period of time and at a prescribed temperature regime, welding, folding, cutting, polishing, etc.). The product which may be yielded as the outcome of such sequence (or, occasionally, the failure to produce such a product) may be quantified with some value.

For example, such values may include:
a. The amount of raw material used for the generation of the product.
a. The market-value of such product.
b. The cost of the resources used in the manufacturing of the product.
c. The physical dimensions of the product.
d. The amount (and/or types) of defects in the product.

Attributing such value to the interactions (i.e., to stages of the production) according to the teachings of method 600 (and likewise by using system 200) enables an efficient utilization of production resources. For example, apportionments of the over-all cost of the resources used in the manufacturing of the product may be attributed to the different production stages, and thereafter be compared to the actual cost of each of these stages. Significant discrepancies between such actual costs and apportioned cost fraction may reveal inefficiencies in the production process.

In another example, the amount of defects may be attributed to different production stages (e.g., heating), and therefore efficient manufacture conditions (e.g., temperature regime) may be found and utilized, thereby enabling efficient utilization of production resources.

Other examples would present themselves to the ordinarily skilled reader.

Some examples of sequence of user interactions which include interactions with more than one user may be: User A's ‘like’ can trigger an interaction for user B (thus two separate interactions); User B seeing that User A ‘liked’ a product or company on his Facebook® feed, and then clicking on the link; User B seeing an ad on Facebook® for a company or product and the ad informed him that his friend, User A ‘liked’ that company or product (this may be also referred to as a social impression).

Other examples of cross-user interactions may be possible, for example, social earned media—as user A fan event (e.g., ‘like’) may be displayed on his friend's (e.g., User B) social page feed (e.g., wall) causing user B to interact with the advertised content through an impression, and possible other, subsequent interactions.

Step 610 of method 600 includes obtaining information of interactions which may be included in the sequence of interactions. At least one of the interactions of the sequence includes communication of digital media over a network connection. Referring to the examples set forth with respect to the previous drawings, step 610 may be carried out by an interface such as interface 210 (either by instructions from processor 220, or otherwise). The information obtained in step 610 may pertain to the interactions of the sequence, or only to some of them. It may be assumed that the sequence includes interactions for which information may be obtained, and an original sequence may be used to determine a sequence that includes interactions for which information may be obtained.

As aforementioned, at least one of the interactions of the sequence includes communication of digital media over a network connection. Such interactions may include the previously offered examples or other types of interactions such as —clicking or viewing by the user of a digital media advertisement, digital purchase of a product, and possibly digital transaction (e.g. provisioning of a purchased mp3 file), signing-in to a website or a service, social media interactions, e-mails, television advertisements, smart TV advertisements, and so on. However, the sequence of interactions may also include other types of interactions of which information may be available, such as—mailing a physical catalogue to the user, identifying the user in a physical location (e.g. by location-based social networking such as “four Square™”), a sale-talk in a physical store, and/or the like.

Step 610 of obtaining information may include obtaining information pertaining to the individual interactions, and may also include obtaining information pertaining to groups of interactions (either the entire sequence or parts thereof). For example, information pertaining to groups of interactions may include statistics regarding the interactions (e.g., the amount of social media interactions, total time spent by the user in a web site of the marketer in all of the interactions, average time between interactions, total number of interactions, time from first interaction to conversion and/or the like).

Step 610 may include generating some or all of the information obtained, receiving some or all of the information obtained, and/or selecting some or all of the information obtained out of larger database.

Method 600 may also include (e.g., as part of step 610) defining the sequence of interactions. For example, such a step of defining may include selecting a group of interactions out of a larger database of interactions. The defining of the sequence may include selecting a group which includes the interactions that comply to one or more selection criteria: e.g., interactions with a group of one or more identified users, interactions occurring within a predefined time frame, interactions over a group of one or more preselected advertising channels, interactions pertaining to a subgroup of advertised products but not to others, and so on.

Method 600 continues with step 620 of computing a performance assessment for the sequence of interactions, based on the obtained information and on an assessment scheme which may be based on a statistical analysis of historical data of a plurality of sequence of interactions. The computing of the performance assessment may be based on properties of the individual interactions of the sequence and/or on properties pertaining to more than one interaction of the sequence. Optionally, step 620 may include computing the performance assessment based on a calibrated assessment scheme and on the properties relating to the at least one interaction out of the sequence of interactions. The assessment scheme may be determined by a human expert but may also be determined by a computer processor (e.g., based on statistics of many sequence of interactions).

Optionally, the group of properties, on which the computing of step 620 is based, includes at least one property which may be unrelated to a time in which any of the interactions occurred. Specifically, in such a variation at least one of the properties, on which the computation of step 630 may be based, may be not related to any of the following:
a. a time at which any of the interactions occurred;
b. time passed between any two of more of the interactions of the sequence;
c. time passed between any of the interactions to another event or point in time;
d. relation of order between any two or more of the interactions of the sequence.

Some of the properties of the interactions, on which step 620 may be based, relate to time (e.g., in addition to other properties such as the type of channel over which one or more of the interactions occurred).

Referring to the examples set forth with respect to the previous drawings, step 620 may be carried out by performance assessment module such as performance assessment module 235. The computation of step 620 may be based on various types of properties—each pertaining to a single interaction or to more than one interaction. Additionally, the computing of step 620 may be based on additional information other than the properties which relate to the at least one interaction.

The interactions-related properties, on which the computing of step 620 may be based, do not pertain only (if at all) to the order of the interactions within the sequence. The computing may be based on properties of the interactions such as (although not limited to) any combination of the following types of properties:
a. properties quantifying relative quality of the interaction, of types of communication or advertisement channels used by the respective interaction;
b. properties of at least one subset of interactions of the sequence, the subset including multiple interactions (e.g., combinations—i.e., ordered or unordered sequences—of interactions of different types; amount of interactions of a given type in the entire sequence, temporal relations between interactions (generally or these of predefined types, and/or the like);
c. properties of elements that triggered interactions of the sequence (e.g., of a keyword in an interaction that involves keywords, e.g., the length of that keyword, whether such keyword includes or otherwise pertains to a pre-identified commercial brand or other advertised entity or not, and/or the like).
By way of example, such keywords may indicate a type or classification of the conducted search (which involved the keywords). Such typing may refer to the scope of the search (whether this search was relatively broad/generic, e.g., a search for “cellular phone” relatively narrow/specific, e.g., a search for “Samsung Galaxy S3”). Another typing may pertain to the assumed purpose of the search (e.g., resembling a search in an index, for finding a known website, or for finding previously unknown information; navigational/non-navigational search);
d. properties which pertain to the creative media used in an advertisement involved in at least one of the respective interactions (e.g., copy, size, content, images, videos);
e. properties which pertain to an advertised entity associated with the interaction (e.g., properties pertaining to a commercial company, a brand, a product, a service, and/or the like);
f. properties which pertain to an advertisement provided to a user in the interaction;
g. properties which pertain to an estimated phase of a process-to-conversion model to which the interaction belongs (e.g., attention; interest; desire; action);
h. properties of the sequence of interactions which pertain to the order in which interactions of different types may be ordered;
i. properties of the sequence of interactions which pertain to elapsed time between the interactions and between the interactions and conversions;
j. properties of the user, i.e., the ‘interactor’ (e.g., its personal characteristics, its location and/or the like);
k. properties of the platform used for the interaction (e.g., a mobile device, a desktop and/or the like)

While the computing of step 620 may be based on the properties of individual interactions of the sequence, it may also be based on patterns of such properties across the sequence of interactions.

The computing of the performance assessment in step 620 may be used for different uses. Possibly, the computing of step 620 may enable efficient utilization of communication resources, and/or of other types of resources. This efficient utilization of resources (and especially of the communication resources) may be part of method 600. Such communication resources may include, for example, any combination of one or more of the following: advertising resources, communication hardware resources, advertisement channel resources, and so on). Method 600 may be implemented as a computerized prediction method for assessing an optional future conversion of a selected user based on a history of interactions with the selected user, that method includes executing by a processor: (a) obtaining information pertaining to interactions with the selected user which may be included in a sequence of user interactions associated with the selected user, wherein at least one of the interactions of the sequence includes communication of digital media over a network connection; and (b) computing a conversion assessment for the sequence of interactions, based on the obtained information and on an assessment scheme which may be based on a statistical analysis of historical data of a plurality of sequence of interactions; wherein the conversion assessment pertains to the optional future conversion of the selected user which may be valuable to an advertiser whose digital media was communicated to the selected user in at least one interaction of the sequence.

Step 620 may include computing of multiple performance assessments, each of which may be determined based on a different combination of obtained information and assessment scheme (which may be based on a statistical analysis of historical data of a plurality of sequence of interactions). That is, the different performance assessments may be computed based on different assessment schemes, based on different portions of the information obtained in step 610 (and/or on different processing of information obtained may be step 610), or based on data differing in both of these manners.

For example, based on a single sequence of interactions (of which information may be obtained in step 610), multiple performance assessment may be computed. Different performance assessment may be computed for example:
a. For different types of performance (e.g. for different types of conversions, for estimating expected costs until a conversion);
b. Based on different assumptions regarding future events (e.g. based on different estimations regarding costs of future interactions with the user, estimating the cost to conversion);
c. Based on different assessment criteria (e.g. likely performance assessment” vs. “worst case” assessment);
d. Assuming different future interactions (e.g. given a past sequence of events, assessing the likelihood of attaining a conversion for each one out of possible future advertisements that may be presented to the user);
e. Other factors.

This may also be regarded as reiterating step 620. The variations discussed with respect to step 620 (or to steps based on its results) may be implemented for any one or more of multiple instances of computing.

While the performance assessment may be an assessment of the likelihood that the sequence would lead to a conversion (or a conversion-rate assessment), the performance assessment may have different meanings in different implementations.

In Internet marketing, conversion rate may be the ratio of visitors who convert casual content views or website visits into desired actions based on subtle or direct requests from marketers, advertisers, and content creators. Examples of conversion actions might include making an online purchase or submitting a form to request additional information. The conversion rate may be defined as the ratio between the number of goal achievements (e.g. number of purchases made) and the visits to the website (which may have resulted from ads displayed in response to the specific keywords). For example, a successful conversion may constitute the sale of a product to a consumer whose interest in the item was initially sparked by clicking a banner advertisement.

The performance assessment may also be an assessment of the number of future interactions expected before a conversion may be reached (or even before a valid estimation that a conversion may be/may not be expected may be reached), of the time before a conversion (or like estimation point) may be reached, of the cost before a conversion (or like estimation point) may be reached, an assessment of the revenue from the conversion (e.g. which products may be the user likely to end up buying), and/or the like.

As aforementioned, the computing of the performance assessment in step 620 may be based not only on the obtained information which pertains to interactions of the sequence, but also on an assessment scheme (which may be a “calibrated assessment scheme”). The assessment scheme, on which the computing of step 620 may optionally be based, may be implemented in different ways. An assessment scheme may be a set of one or more rules according to which the performance assessment may be computed, based on information pertaining to interactions of the sequence. Some assessment schemes which may be implemented may include simple rules (e.g., “the process assessment may be equal to a portion of the interactions of the sequence which may be associated with a brand related keyword”), while other possible assessment schemes may include substantially more complex rules. While some assessment schemes may be strictly deterministic, other may include some random or semi-random aspects.

In addition, an assessment scheme may be determined by an expert, regardless of any specific statistical data, or based (solely or partly) on statistics of historical interactions logs. For example, order-based attribution-scheme from an expert may determine that the process assessment may be equal to a portion of the interactions of the sequence which may be associated with a brand related keyword.

A calibrated assessment scheme may be an assessment scheme which may be based on an analysis (e.g., a statistical analysis, possibly also linguistic analysis, and/or the like) of historical data which includes multiple sequence of interactions. Optionally, the historical data which may be analyzed for the generation of the calibrated assessment scheme may also include the historical outcomes of some or all of these sequence (e.g. which of these sequence ended up in a conversion and which didn't, what was the physical dimensions of the output product in each of these sequence, and so on). The calibrated assessment scheme may be calibrated in that it may pertain to sequence of interactions which fulfill a selection condition, and may be used to sequence of interactions which fulfill the same selection condition.

For example, the following calibrated assessment schemes pertain to sequence of interactions which fulfill the following conditions:
a. sequence of interactions which may be associated with a certain advertiser.
b. sequence of interactions which may be associated with a certain country or jurisdiction.
c. sequence of interactions which may be associated with a certain line of products of a given advertiser.
d. sequence of interactions which may be associated with a certain vertical.

Furthermore, the calibrated assessment scheme may be an assessment scheme which may be based on an analysis of partial historical data (i.e., not all of the available historical data) which may be selected out of a larger log of historical data based on compliance of the selected sequence (and/or interactions) with one or more such selection rules.

For example, a log of historical data which pertains to a single advertiser may be divided based on the line of product (e.g., cellular phones vs. televisions), and each of these parts may be used for the generation of a respective calibrated assessment scheme. Afterwards, a performance assessment for a sequence of interactions which may be associated with televisions (e.g., a conversion in which a television was purchased online) would be computed based on the assessment scheme calibrated based on the television-related historical data, while a performance assessment for a sequence of interactions which may be associated with cellular phones (e.g., a conversion in which a charger for an iPhone™ cellular phone was purchased online) would be computed based on the assessment scheme calibrated based on the cellular-phones-related historical data.

The calibrated assessment scheme may be updated from time to time based on new historical data. That is, method 600 may further include repeatedly updating the calibrated assessment scheme (at regular intervals or otherwise), wherein each updating may be based on historical data which may be more recent than any of the previous instances of updating (that is, at least some of the historical data, on which such updating may be based, may be more recent than any of the previous instances of updating).

Method 600 may be used for building and utilizing a calibrated assessment scheme that may be unique to an advertiser, for computing performance assessment to relevant sequence of user interactions. Such a method would include executing by a processor: (a) analyzing historical data of a plurality of sequence of interactions with a plurality of users, each of the plurality of sequence including at least one interaction which may be associated with the advertiser; (b) determining the calibrated assessment scheme based on results of the analyzing (e.g., by determining weights such as in step 870 of FIG. 8); and (c) computing a performance assessment for a sequence of user interactions, at least one of which may be associated with the advertiser, according to the previously discussed steps of method 600.

The analysis of the historical data may reflect, for example, causal relationship between interactions (interactions causing other interactions) and causal relationship between interactions and conversions. The analysis may include analysis of sequence which did not contain conversions.

Method 600 may include step 630 of updating a database entry based on the performance assessment computed in step 620. Referring to the examples set forth with respect to the previous drawings, step 630 may be carried out by a database such as database 270, or by a database management module (not illustrated) implemented on a processor such as processor 220. The updating may include a step of processing the computed performance assessment (and possibly additional data) to determine the new value for the database entry.

The updating of step 630 may include updating a database entry associated with one of the plurality of interactions, a database entry associated with one of the interaction properties which may be used in the computing, a database entry associated with a pattern of one or more properties across a group of interactions, and/or the like. Such a process of updating may be repeated (e.g., more than one interaction, more than one pattern, more than one property, and any combination of the same).

For example, the updating may include updating assessments of a potential contribution of a type of interaction to the realization of a future event. For example, one or more of the following entry types may be updated, pertaining to one or more interactions types, one or more pattern types, one or more property type, and/or the like:
a. An assessment of the likelihood that an interaction of the respective interaction type would lead to a conversion;
b. An assessment of the likelihood that an interaction of the respective interaction type would lead to an interaction of another type (e.g., the likelihood that a search-engine originated interaction would lead to a social-network based interaction).

Optionally, step 630 may include updating an entry which pertains to a sequence of interactions, or to a sequence of interaction types. For example, one or more of the following entry types may be updated, pertaining to a sequence of interactions of one or more interaction types:
a. An assessment of the likelihood that a sequence of interactions of one or more interaction types (e.g., an interaction pertaining to advertiser's brand followed by two interactions which do not pertain to that brand; three interactions within one hour, and/or the like) would lead to a conversion.
b. An assessment of the likelihood that a pattern occurring in at least one property of the interactions across a subgroup of some or all of the interactions of the sequence which may be of one or more interaction types (e.g., an interaction pertaining to advertiser's brand followed by two interactions which do not pertain to that brand; three interactions within one hour, and/or the like) would lead to a conversion
c. An assessment of the likelihood that that a sequence of interactions of one or more interaction types would lead to an interaction of a known type.

One interaction may lead to another and that this other interaction may lead to a conversion. For example, an interest aroused in the client by a display ad may lead the customer to later search for the advertiser's site using a search engine. In other scenarios, two interactions in a sequence may be completely unconnected. Step 630 may be implemented for detecting and/or for reflecting whether there may be a causal relationship between interactions (or interaction types), and in cases where such causality does exist assign credit to both indirect and direct players in the conversion path.

That is, optionally method 600 may include statistically analyzing historical data of a plurality of sequence of interactions with at least one user for detecting one or more causal relationships between different interaction types (i.e., if an occurrence of one or more of these interactions type indicates high likelihood that interaction of another one of these interaction types would occur), based on an analysis of the historical data, and updating the assessment scheme so that both direct and indirect interactions in the sequence would contribute to the computation of the performance assessment, thereby reflecting the detected causal relationship (i.e., to interactions contributing to the conversion directly and to interactions contributing to the conversion indirectly).

In addition to causality, the updating of step 630 may also be implemented for detecting and/or reflecting synergy. A customer looking to buy a television may be influenced by the paid search ads that appear and that they clicked on while searching for a specific model using a search engine. They could also be influenced by seeing an ad on a social networking site such as Facebook® that reports that one or more of their friends “likes” a certain online electronics store. But the combined influence of seeing the same store come up in both the paid search ads and on Facebook® may be larger than the influence of each of those individual engagements. The updated entries may later be used so that such synergies may be detected and so that the performance assessment would be computed appropriately when they occur.

That is, optionally method 600 may include statistically analyzing historical data of a plurality of sequence of interactions with a plurality of users for detecting synergy between different types of interactions, wherein the computation of the performance assessment may be based on the detected synergy. The detecting of such synergy may be a part of the statistical analysis which serves for the determination/updating of the calibrated performance assessment module (if implemented), and the utilizing of the synergy in the computing may in such case be a result of utilizing the calibrated assessment scheme which reflects the detected synergy. The detection of the synergy may be explicit or implicit (i.e., the method may include detecting such synergy even if such synergy may not be explicitly pointed out as “synergy”).

Method 600 may also include step 640 of communicating with one or more users, based on the computed performance assessment. Referring to the examples set forth with respect to the previous drawings, step 640 may be carried out by a communication module such as communication module 280. The communicating of step 640 may include providing advertisements to the one or more users, or providing other information, and may also include receiving information from such one or more users.

The efficient utilization of communication or advertising resources (e.g., as part of step 640) may be a result of utilizing the aforementioned database for future communication with the client, and especially using one of the entries updated at optional step 630, based on the computation of step 640.

For example, the efficient utilization of communication resources (which may include advertising resources, communication hardware resources, advertisement/marketing channel resources, and so on), enabled by the computing of step 620 may include reducing an amount of data communicated to the user, thereby reducing an amount of communication resources. For example, parameters of the user, and/or of a posterior possible interaction with the user may be analyzed based on the results of the computing (e.g., based on the database referred to in the context of step 630). If a result of the analysis may be that a given interaction with the user at that opportunity should be limited or altogether avoided, a clear reduction in communication costs (financial, datalink, processing power, and/or the like) may be obtained.

Efficient utilization of communication or advertising resources may also be achieved by better targeting the user with targeted advertising in view of the computed performance assessment (e.g., based on the database referred to in the context of step 630).

Another example of utilization of advertising resources may be changing elements which may be involved in an interaction, as changing a keyword which was involved in a search engine marketing (SEM) campaign in view of the results of the computing of step 620. Yet another example of utilization may be changing inputs to other mechanisms and systems that interact or otherwise connect to the interaction, as changing the bid with respect to keywords that may be involved in a search engine marketing (SEM) campaign in view of the results of the attribution.

In addition to regular uses of the term “efficiency” and its derivative forms (e.g., “efficiently”), the term as used herein should be expansively construed to cover ways of putting the relevant resources into good, thorough, and/or careful use, especially regarding the utilization of these resources (thereby consuming a relatively small amount of such resources for providing a desirable outcome).

Reversion is now made to step 620 and to the various kinds of properties which may be used in the process of computing the performance assessment.

Optionally, the computing may include computing the performance assessment based on properties quantifying relative quality of the interactions. While different types of interactions (e.g., e-mails, telephone conversations, electronic advertisements, social media interactions, paper advertisements, videos watched, and/or the like) may be qualified by different types of quantities, many such quantified properties used for assessing quality of the interactions may be implemented. For example, such properties quantifying relative quality of the interactions may include:
a. Duration of the interaction (e.g., time spent on website, duration of a phone conversation, percent of video length watched by the user, and/or the like);
b. Amount of data transferred to the client during the interaction (e.g., amount of web pages viewed);
c. Engagement of the user in the interaction (e.g., view, mouse-over, click in, click out)

Such properties quantifying relative quality of the interactions may also quantify relative quality of a group of interactions (e.g., interactions of the same type). For example, statistic products of the example properties (e.g., minimum, maximum, average, median, mean, standard deviation, and/or the like). Other examples include:
a. Parameters qualifying response of user (or users) to such interactions (e.g., bounce rate);
b. Redundancy in interactions (e.g., times in which the interaction resulted from the same keyword entered by the user);

Optionally, the computing may include computing the performance assessment based on properties of at least one keyword entered by a user which triggered at least one interaction of the sequence.

Optionally, the computing may include computing the performance assessment based on properties which pertain to an advertisement provided to a user in at least one of the interactions of the sequence. Such properties pertaining to such an advertisement may be, for example, the type of the advertisement (e.g., video, non-video, image, animated-gif, text, and/or the like), duration of the advertisement, size of the advertisement (in centimeters, in pixels, and/or the like), an affectivity score of the advertisement (e.g., based on previous success/attribution analysis), its source (e.g., being sent from a friend, being included in a social-media feed, and/or the like), and so on.

Optionally, the computing may include computing the performance assessment based on types of advertisement channels used by the respective interactions. The types of communication may be analyzed in different resolutions. By way of example, a very coarse resolution may be machine interactions vs. human interactions. A finer resolution would be the interactions technology used (e.g., e-mail, video, text ad, social-media, telephone, billboard). A yet finer resolution would differentiate, for example, between video advertisements embedded in an external website to video streamed at the website of the publisher, contextual display advertising, paid/non-paid advertising, and so on.

Optionally, the computing may include computing the performance assessment based on properties of elements that triggered interactions of the sequence. Interactions may be triggered by actions of the user who may be a party of the interaction (e.g., by entering a keyword into a search engine), by the marketer (e.g., by sending a newsletter and/or an advertisement to a mailing list of users), or by actions of another user.

The properties pertaining to such elements (or events) may be, for example, parameters of the keyword entered (e.g., its length) or other element involved in the interaction, demographic parameters of a user (e.g., age, gender), and may also be meta-parameters such as—does the keyword include a brand-name of the marketer, does the keyword include a specific product name, manufacturer or model and/or the like. Parameters which pertain to the event which triggered the interactions may be time of the event (e.g., the time of the day in which the keyword was entered by the user), the location of the event, and/or the like. The event which triggered the interaction may be another interaction (which may be part of the same or different sequence).

Optionally, the computing may include computing the performance assessment based on properties of at least one keyword entered by a user which triggered at least one interaction of the sequence.

Optionally, the computing may include computing the performance assessment based on properties which pertain to an advertised entity associated with one or more interactions of the sequence of interactions. The advertised entity may be the marketer itself (for example, such a property is: whether the keyword includes the brand-name of the marketer), and may also be an advertised product or a service.

By way of example, the user may have ultimately purchased a certain type of product (say, a DELL computer). In view of this, advertisements which were presented to this user and which advertised totally unrelated products (e.g., shoes, razor blades, and/or the like) may be attributed smaller apportionments than advertisements (or other types of interactions) which may be more relevant to the advertised entity (e.g., ones pertaining to computers, electronic gadgets, other DELL products, and/or the like).

Optionally, the computing may include computing the performance assessment based on properties of at least one subset of interactions of the sequence, wherein the subset includes multiple interactions. The subset of interactions may be defined in different ways.

For example, such properties of a subset of interactions may include:
a. Duration between two (or more) interactions of the subset;
b. Causal relations between two (or more) interactions of the subset;
c. Patterns occurring in at least one property of the interactions across the subset of interactions (e.g., considering the property Brand (B) vs. Non-Conversion (NB) as a type of a single interaction, the property of the subset may be defined as whether the pattern NB-NB-NB-B occurs in the ordered subset);
d. The number of users that were a party to at least one of the interactions (and possibly the number of interactions having at least a predefined number of users participating therein);

The subset may be a proper subset of the sequence of interactions (i.e., include a smaller number of interactions), but in other alternatives it may include the entire sequence of interactions. Using the terminology of a path of interactions (also referred to as “conversion funnel”, “Path to conversion” or P2C, where applicable, or possibly also just as “Path”), the computing may include computing the performance assessment based on patterns occurring in at least one property of the interactions across the sequence of interactions, i.e., —across the path.

As aforementioned, the computing of the performance assessment in step 620 may be based on patterns which may be detected in the sequence of interactions.

Reference is now made to FIG. 7, which shows a flowchart of a fifth example computerized method 700 for attribution of values to interactions in sequences. Step 710 of method 700 may be similar to step 610 of method 600.

Referring to the example of FIG. 3B, step 740 may include step 742 of matching the sequence to one or more patterns out of at least predefined patterns, based on the obtained information, and step 744 of determining the performance assessment for the sequence based on assessment basis information which may be associated with the one or more matching patterns.

Step 744 may include the determining of the performance assessment for the sequence based on assessment basis information which may be associated with the one or more matching patterns. The assessment basis may be exemplified by a percent (indicative of likelihood), or the assessment basis may be given in units or sizes which may be directly translatable to a performance assessment. For example, the assessment basis may be a class, or parameters of an assessment scheme.

The determining of the performance assessment in step 744 may be based, as aforementioned, on the assessment basis information, but it may also depend on additional information, such as the information obtained in step 710.

Step 760 which includes communicating with one or more users (possibly other users than the one or more which were parties to the interactions of the sequence). Information about such later communication may be obtained at a later reiteration of step 710, and the method may be repeated. Different steps of computing may be based on different assessment logic and/or parameters; especially if those parameters and/or logic may be based on the result of the computing (step 740) or of posterior communication (step 660), but also in other situations.

Reference is now made to FIG. 8, which shows a flowchart of a sixth example computerized method 800 for attribution of values to interactions in sequences. Steps 810 and 840 may be similar and correspond to steps 510 and 540 of FIG. 5, respectively.

The computing of the performance assessment in step 840 may be based, as aforementioned, on properties relating to at least one interaction out of the sequence of interactions. Steps 842 and 844 may be similar and correspond to steps 742 and 744 of FIG. 7, respectively.

Method 800 may include optional step 870 of determining one or more assessment schemes based on a machine implemented statistical analysis of historical data of a plurality of sequence of interactions with a plurality of users. Referring to the examples set forth with respect to the previous drawings, step 870 may be carried out by an assessment scheme processing module such as assessment scheme processing module 265. The computing of the performance assessment in step 840 may be based in such cases on one or more of the at least one assessment scheme determined based on the statistical analysis of the historical data of the plurality of sequence of interactions with a plurality of users.

That is, method 800 may include statistically analyzing the historical data of the plurality of sequence of interactions, and determining the assessment scheme (and possible alternative assessment schemes as well) based on a result of the analyzing.

The statistical analysis of step 870 may be executed for detecting synergy between different types of interactions, wherein the computing of the performance assessment may be based on the detected synergy.

Step 870 may include, for example, determining a weight and/or an assessment basis for each property out of a plurality of properties of sets of interactions (and/or for each pattern out of a plurality of patterns of sets of interactions), wherein the determining of the weight or assessment basis may be based on frequencies of patterns of interactions having the properties. Such sets may include sets including a single interaction each, and/or sets that include more than one interaction each.

Step 870 may also include, for example, determining the assessment schemes based on relative success rates of sets of interactions which possess a given property and/or pattern, with respect to success of other sets of interactions.

The properties may include, for example:
a. Properties quantifying relative quality of the interactions;
b. Types of advertisement channels used by the respective interactions;
c. Properties of at least one subset of interactions of the sequence, wherein the subset includes multiple interactions;
d. Properties of elements and/or events that triggered interactions of the sequence;
e. Properties which pertain to an advertised entity associated with the sequence of interactions;
f. Properties of at least one keyword entered by a user which triggered at least one interaction of the sequence;
g. Properties which pertain to an advertisement provided to a user in at least one of the interactions of the sequence;
h. Patterns occurring in at least one property of the interactions across the sequence of interactions.

Optionally, the statistical analysis of step 870 may be based on relative success of sets of interactions having certain patterns of interactions with respect to success of other sets of interactions having other patterns of interactions.

Step 870 may be repeated from time to time. That is, method 800 may include repeatedly updating the assessment scheme, wherein each updating may be based on historical data which may be more recent than any of the previous instances of updating. Referring to method 800 as a whole, method 800 may be implemented as a computerized prediction method for individual users based on user interactions history. Based on a sequence of interactions which may be relevant to a single selected user, the performance assessment may be computed with respect to that user. For example, the chances that a sequence of interactions with the selected user may yield to a purchasing of a product, the expected revenue from such a transaction, and so on, may be calculated based on a sequence of multiple interactions.

This computation may, in some implementations, be based also on information of interactions with other users, e.g. of another user which entered an e-mail of the selected user so that an advertisement or a greeting card may be sent to the selected user.

The sequence of user interactions in such cases may be therefore associated with the selected user, and at least one of the interactions of the sequence includes communication of digital media over a network connection to the selected user.

The computing would include computing the performance assessment for the sequence of interactions associated with the selected user, that computing being based on the obtained information with respect to the specific user and on the assessment scheme.

Optionally, the computing may be based on properties relating to at least one interaction out of the sequence of interactions, wherein the properties include properties of at least one subset of interactions of the sequence (the subset includes multiple interactions) and at least one property out of the following types: (a) properties quantifying relative quality of the interactions, (b) types of advertisement channels used by the respective interactions.

The performance assessment computed in step 840 may pertain to an optional future interaction with the selected user which may be valuable to an advertiser whose digital media was communicated to the selected user in at least one interaction of the sequence.

Steps 850 and 860 may be similar and correspond to steps 750 and 760 of FIG. 7, respectively.

Reference is now made to FIG. 9, which shows a flowchart of a seventh example computerized method 900 for attribution of values to interactions in sequences.

Method 900 may be used for retargeting, for example, by performing the process illustrated in FIG. 9. Behavioral retargeting (also known as behavioral remarketing, or simply, retargeting) may be a form of online targeted advertising by which online advertising may be targeted to consumers based on their previous Internet actions, especially in situations where these actions did not result in a sale or conversion.

For any given user, implementing of method 900 enables to assess the impact which different advertisements (or other actions), when communicated to the user, may have on his chances to convert. This may enable to decide whether and how much to bid to show him each of the ads in which digital media may be included, and possibly to select which one or more ads to bid on.

Method 900 includes the steps of other methods, such as methods 300, 400, 500, 600, 700, 800, and the like (among other steps), and variations of other methods, may also be applicable for method 900.

The sequence whose information may be obtained in step 910 may be referred to, in the context of method 900, as “the original sequence”, thereby differentiating it from other hypothetical sequence which may be generated on its basis.

Following step 910, method 900 includes step 920 which includes defining multiple possible future interactions which may occur after the original sequence of interactions, based on the obtained information.

Method 900 continues with step 930 in which, based on the obtained information and on the multiple possible future interactions, information of interactions may be acquired for each out of a plurality of hypothetical sequence of interactions, wherein each of the hypothetical sequence of interactions includes the original sequence of interactions followed by one or more of the possible future interactions.

Method 900 continues with executing step 940 for each out of the multiple hypothetical sequence, computing for each of them a performance assessment, which may be followed by step 980 of selecting one or more out of the possible future interactions based on the performance assessment computed for different hypothetical sequence, and possibly on additional data (e.g. estimated cost of implementing the different alternatives). For example, if the performance assessment of hypothetical sequence A may be 1% larger than that of hypothetical sequence B, but the cost of executing the future interactions included in hypothetical sequence A may be 10% larger, the future interactions of hypothetical sequence B may be selected. Steps 942 and 944 may be similar and correspond to steps 742 and 744 of FIG. 7, respectively.

Optional step 990 includes executing the selected future interactions.

When method 900 may be used for retargeting a selected user with an advertisement which may be selected based on previous Internet interactions with the selected user, the selecting of step 980 may include selecting an advertisement out of multiple possible advertisements, and the executing of step 990 may include presenting the selected advertisement to the selected user.

Some use cases are presented, by way of non-limiting examples.

Any of the methods may be used, for example, for lead generation.

Lead generation may be a process of generating consumer interest or inquiry into products or services of a business, especially in Internet marketing. Leads may be generated in various ways such as advertising, organic search engine results, referrals from existing customers, and/or the like. Such leads, however, differ in their quality (the likelihood that value may be generated for the advertiser from the user to which the leads point, and the expected value). Quality may be generally indicative of the propensity of the inquirer to take the next action towards a purchase or another type of conversion.

The performance assessment computed may be indicative of these very properties, and therefore the quality of each selected user as a lead may be determined. This information may be used by the party who collects the information, and may also be monetized by selling quality leads to a third party. Computing of multiple performance assessment for determining to which third party this path may be of greater value may enable to select the third party more efficiently and/or profitably.

Assigning a value to the sequence based on the performance assessment. For example, based on the likelihood of conversion of the sequence, a price (i.e. the value in that case), may be determined in which this lead may be sold to a third party.

The lead generation process may include: assigning to each out of multiple sequence of interactions (each of the sequence being associated with a different user) a value according to the disclosed methods of value assignment (thereby assigning different values to the different users associated with the respective sequence), and exchanging contact details of the different users with a third party in return for transactions by the third party whose content may be determined in response to the values assigned to the different users. The return transactions may be transactions of money (be it a legal tender, an electronic currency, and/or the like), and the returning transactions may also be transactions of physical goods, of material, of information, and so on.

A method for lead generation may also be implemented by: (1) assigning different values to the different users associated with multiple respective sequence of interactions, by executing for each out of multiple sequence of interactions, each of the sequence being associated with a different user: (a) computing a respective performance assessment for the sequence of interactions, and (b) assigning a respective value to the sequence based on the respective performance assessment; and (2) exchanging contact details of the different users with a third party in return for transactions by the third party whose content may be determined in response to the values assigned to the different users.

Methods may be used for real time bidding (RTB) and for communication with RTB servers, for example, by performing the following process:
a. Executing method steps for each out of a multiple sequence of interactions, each of these multiple sequence includes at least one interaction which complies with a predefined criterion. This executing of method steps results in computing for each of these sequence a performance assessment which may be an assessment of an optional future conversion to which that sequence of interactions may lead.
b. based on the computed performance assessments, updating a value assignment parameter; and
c. selectively initiating a communication of digital media which complies with the predefined criterion, wherein the selective initiation of the communication includes bidding on an advertisement, wherein a magnitude of the bidding may be based on the value assignment parameter.

Such a predetermined criterion may be, for example, the product advertised, the size of the advertisement, and any one of the aforementioned properties. More than one criterion may be used.

Real Time Bidding (RTB) takes place when a user visits a website, which includes advertisements, upon which a call may be made by a respective Real Time Bidding server to Demand Side Platforms (DSP) or to Ad Networks (Ad Exchange). Based upon the results of these addressees, the RTB server may determine which advertiser gets to serve the ad. Each user has an associated set of attributes, which may be transferred from the RTB server to the DSPs, which may then determine whether the user has attributes which the relevant advertiser wants to target. Based on the perceived value of this user (determined in step b, for example), a bid may be placed on this ad impression by relevant advertisers (thereby initiating step c). The selection of the advertisement may be based, for example, on the highest bid.

The determining of which bid to place for a specific user at a specific time may be based on the conversion rate of advertisement of the advertiser which complies with such a predetermined criterion. While the estimation of the conversion rate should preferably be as up to date as possible (which uses the most recent data, such as clicks from the last week), some conversions may happen up to several weeks after the click. Therefore, it may be not yet known whether the sequence which included interactions from the last week would yield a conversion or not, and therefore the recent data may be partial. Executing the process may allow predicting the conversion rate based on clicks/paths that have not yet converted but may be likely to do so.

Methods may be used for inventory management, for example, by performing the following process:
a. Executing method steps for each out of multiple sequence of interactions, each of these multiple sequence includes at least one interaction which complies with a predefined criterion. This executing of method steps results in computing for each of these sequence a performance assessment which may be an expected magnitude of an optional future transaction to which that sequence of interactions may lead;
b. based on the computed performance assessments, determining an expected overall magnitude of multiple optional future transactions (e.g. by determining an expected inventory of at least one item to be transacted in the optional future transactions); and
c. selectively initiating a communication of digital media which complies with the predefined criterion, based on the expected overall magnitude (e.g. by selectively initiating a communication of digital media which complies with the predefined criterion, based on the expected inventory).

If there may be a limited inventory of a product or a service (e.g. leads, cars, insurance policies), there may be a need to estimate how much of the inventory has already been sold or should be considered as sold (including conversions that have occurred and such which may occur before the end of the inventory cycle) in order to decide whether and at what pace to continue to invest in communication with users (e.g. by Internet marketing such as search engine marketing, SEM).

Utilizing methods may enable aggregating data of many users. Based on the conversion estimation of many users, it may be possible to determine how many products are likely to be sold. The magnitude may be a conversion rate (especially in cases in which in each conversion a single product may be sold), but may also be indicative of the value and/or amount of product sold in each conversion.

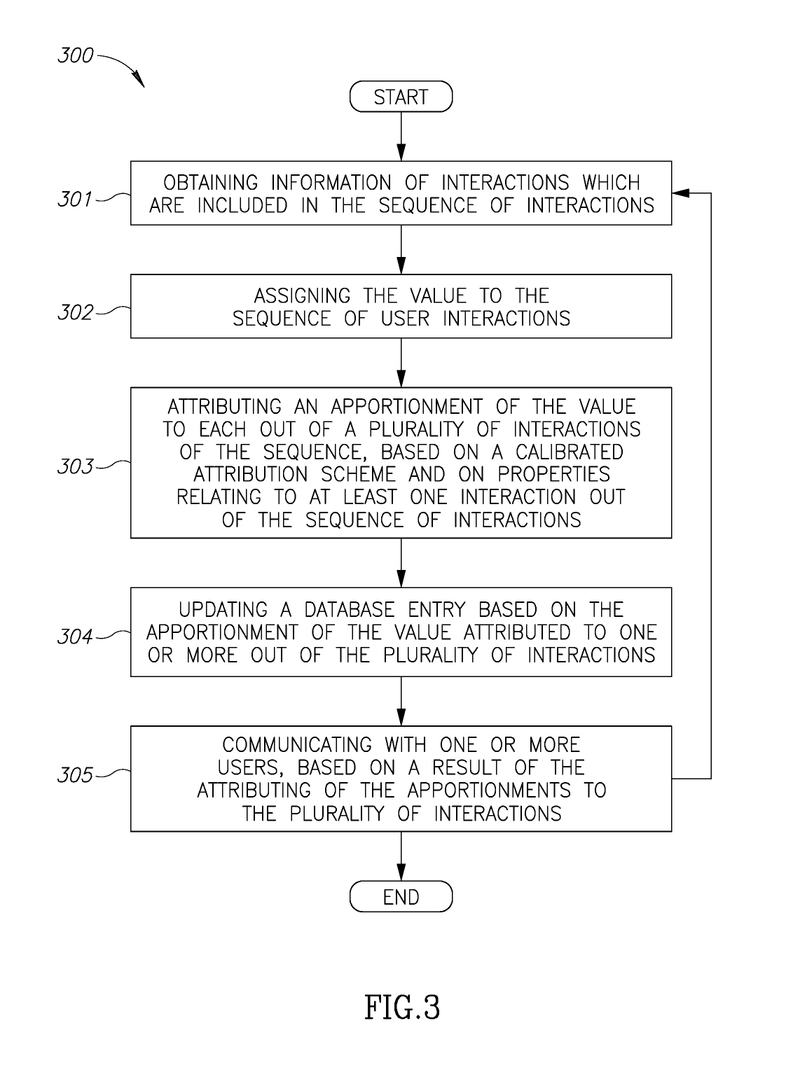

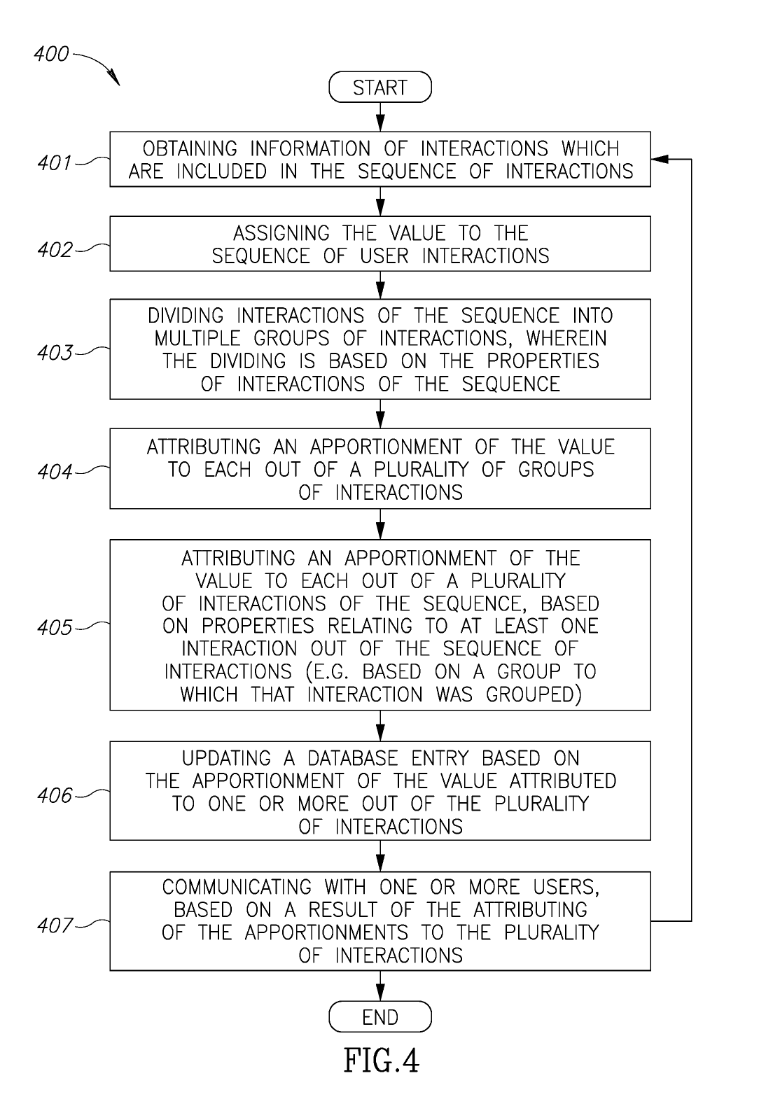

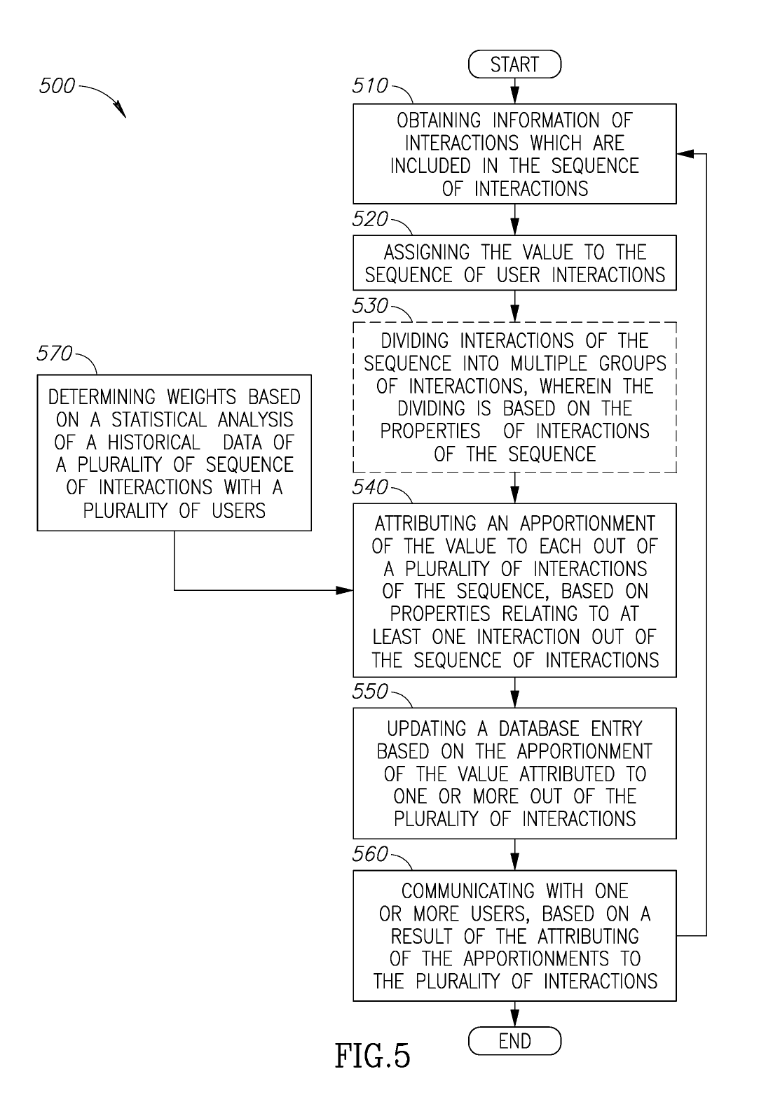

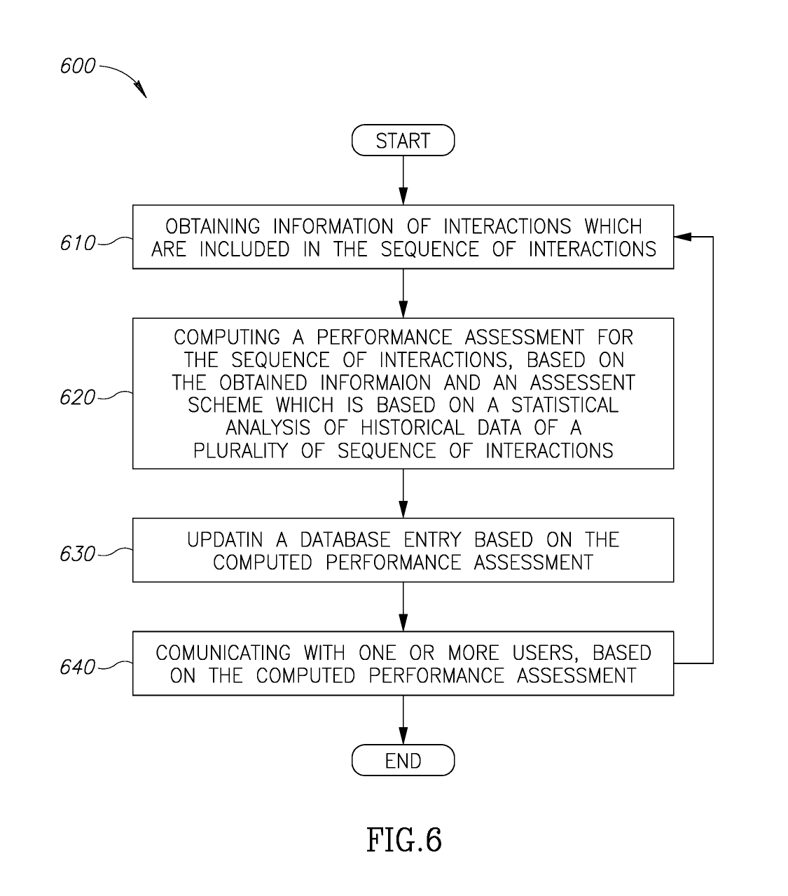

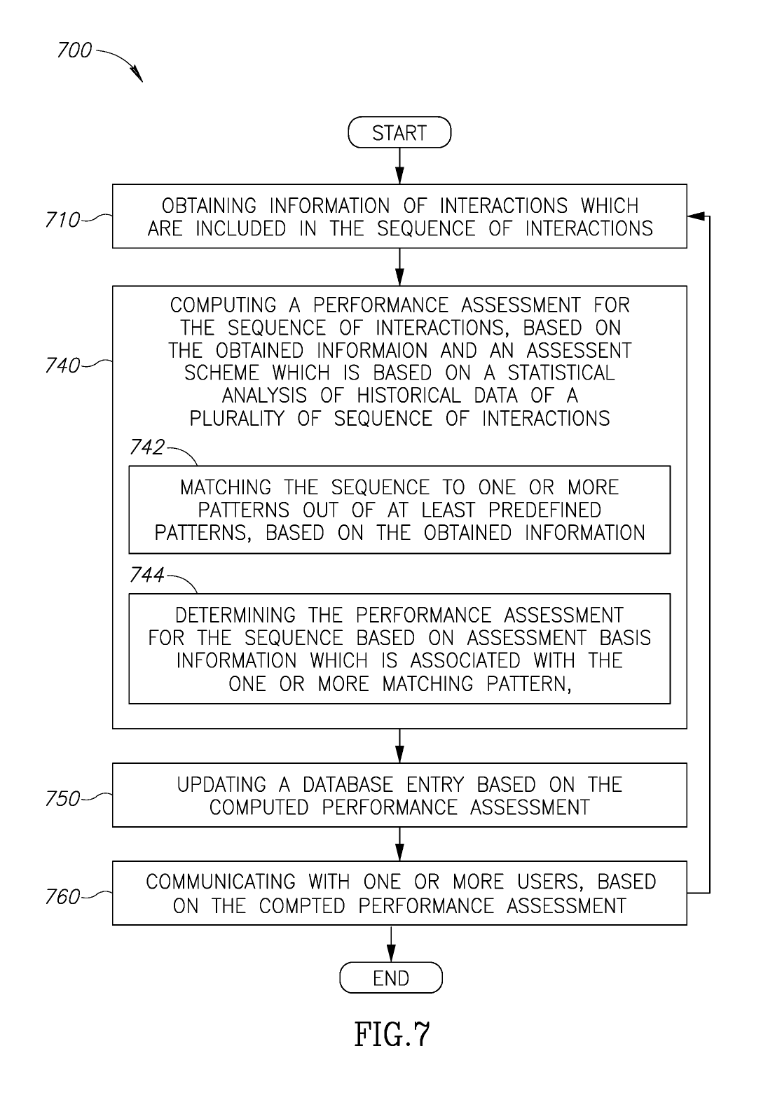

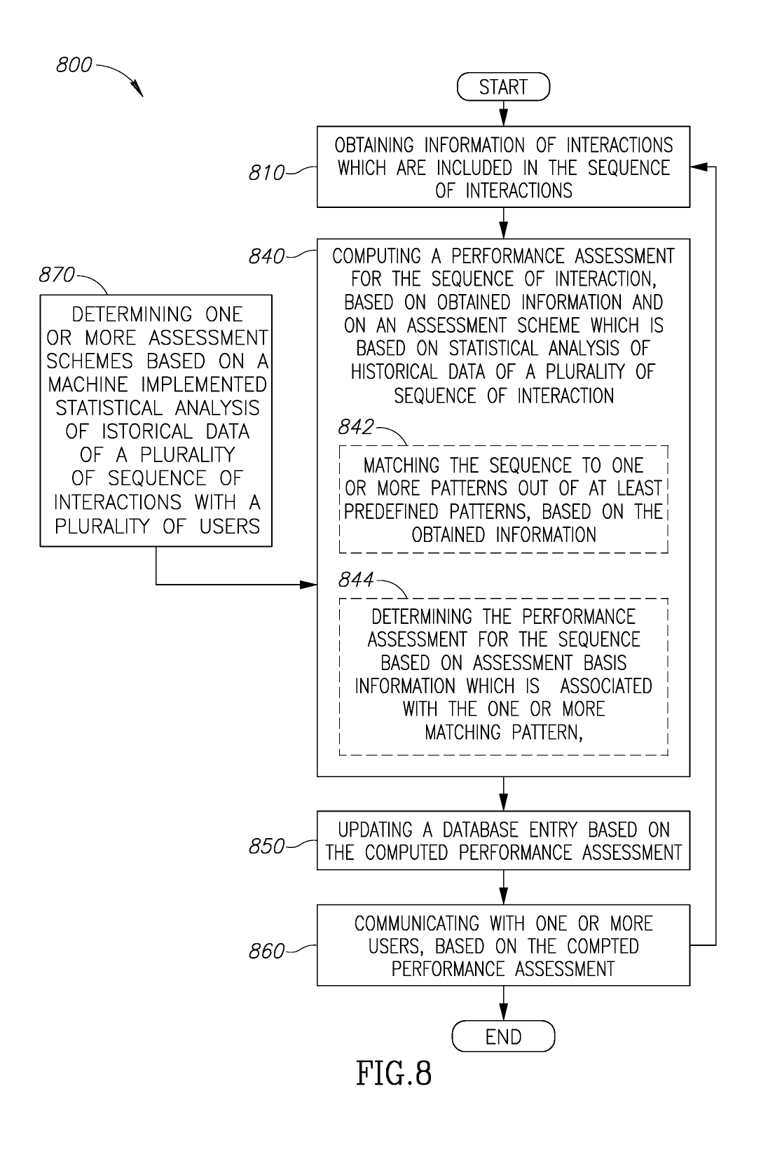

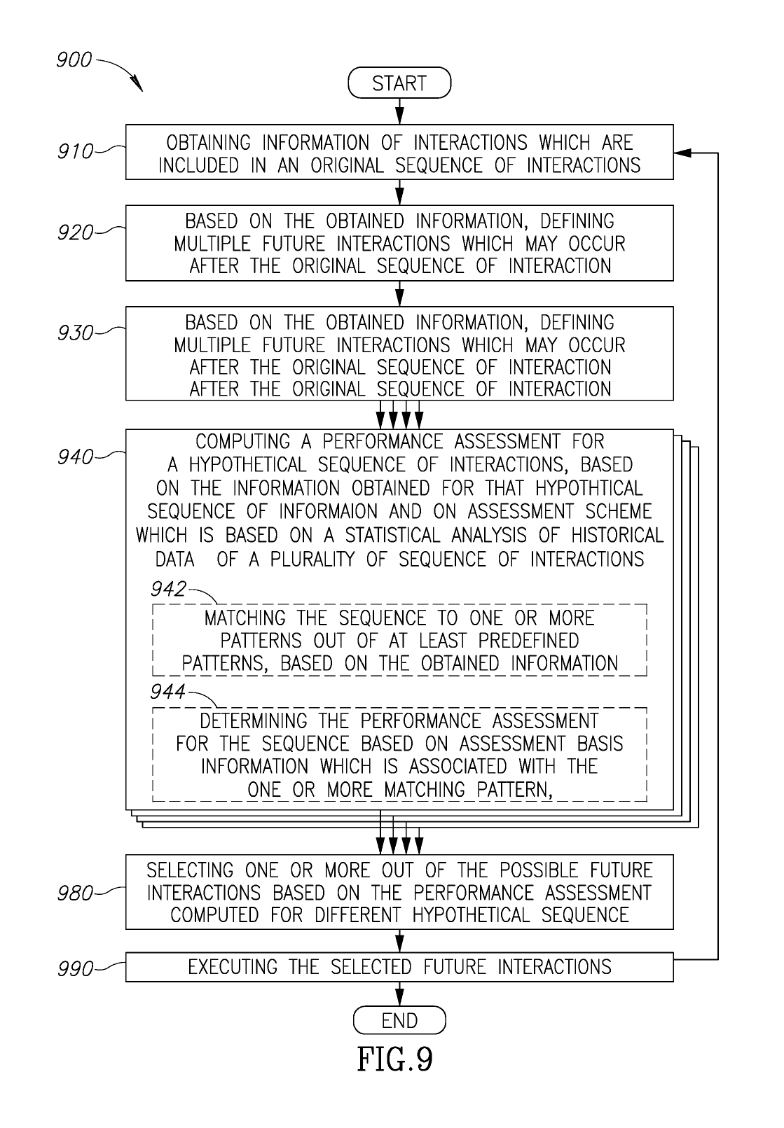

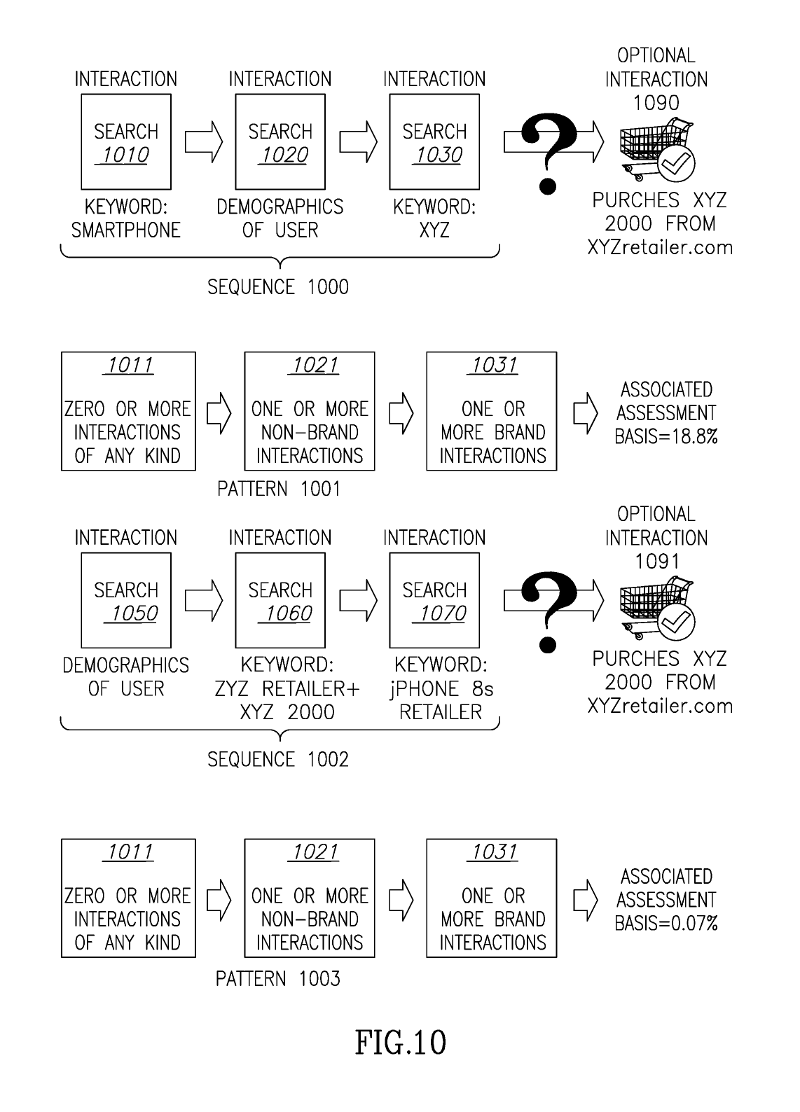

Reference is now made to FIG. 10, which shows a schematic illustration of example pattern determinations of interactions in a sequence and value attribution. Two sequence of interactions, 1000 and 1002, each including three interactions, as well as two patterns 1001 and 1003. Sequence 1001 includes: (1) a first interaction 1010 in which the user reacted to an advertisement provided within a social network in response to the demographics of the users, followed by (2) a second interaction 1020 in which the user reacted to an advertisement provided within a search engine in response to a general query entered by the user (not including a name of the advertiser, which in this case may be assumed to be a retailer named “GalaxyRetailer”); followed by (3) a third interaction 1030 in which the user interacted with an advertisement provided within a search engine in response to another search query entered by the user, in which the user indicated the name of the advertiser (as well as a specific product).

sequence 1002, includes: (1) a first interaction 1050 in which the user reacted to an advertisement provided within a social network in response to the demographics of the users, followed by (2) a second interaction 1060 in which the user reacted to an advertisement provided within a search engine in response to a search query entered by the user, in which the user indicated the name of the advertiser (as well as a specific product); followed by (3) a third interaction 1070 in which the user interacted with an advertisement provided within a search engine in response to another search query entered by the user (not including a name of the advertiser, and indicating another product than the one associated with previous interactions with that user).

The performance assessment which may be to be computed for each of these sequence is, in the illustrated example, the likelihood of a conversion in which the user may purchase the respective product through the website of the advertiser GalaxyRetailer.com.

In the illustrated example, sequence 1001 matches a first pattern, pattern 1001, which ends with one or more interactions which may not be associated with a brand-name of the advertiser, followed by one or more interactions which may be associated with this brand-name. Likewise, sequence 1002 matches a second pattern, pattern 1003, which ends with one or more interactions which may be associated with a brand-name of the advertiser, followed by one or more interactions which may not be associated with this brand-name.

One or more values, referred to as “assessment basis”, may be associated with each of the patterns, and may be used in the computing of the performance assessment. However, the performance assessment computed for a sequence may not be identical to the assessment basis associated with a pattern to which the sequence matches.

The predefined patterns from which the matching patterns may be selected may be defined in many ways. For example, the patterns may be defined as ordered sets of groups of interactions, wherein each group includes a number of interactions (the number may be within a predefined range) whose properties fill at least one selection criterion. Such patterns may be exemplified by patterns 1001. Each group of patterns may be defined by criterions relating to more than one property type. Furthermore, the groups in such definitions of patterns may be partly overlapping.

Some sequence of interactions may be matched to more than one pattern. For example, any of sequence 1001 and 1002 also match a pattern which ends with one or more interactions which may be initiated in a social-network context, followed by two or more interactions which may be triggered in a search engine context, wherein at least one of these two or more interactions may be associated with a brand-name of the advertiser.

Referring, for example, to sequence 1001 and to pattern 1001, the determining may include modifying the assessment basis of 18.8% based on other parameters such as the size of the advertisements provided to the user in one or more of the interactions, or to any other one or more properties selected from property types such as:
a. Properties quantifying relative quality of the interactions;
b. Types of advertisement channels used by the respective interactions;
c. Properties of at least one subset of interactions of the sequence, wherein the subset includes multiple interactions;
d. Properties of elements and/or events that triggered interactions of the sequence;
e. Properties which pertain to an advertised entity associated with the interaction;
f. Properties of at least one keyword entered by a user which triggered at least one interaction of the sequence;
g. Properties which pertain to an advertisement provided to a user in at least one of the interactions of the sequence;
h. and/or any of the other property types mentioned herein.

Similarly, for example, to sequence 1002 and to pattern 1003, the determining may include modifying the assessment basis of 0.07% based on other respective parameters.

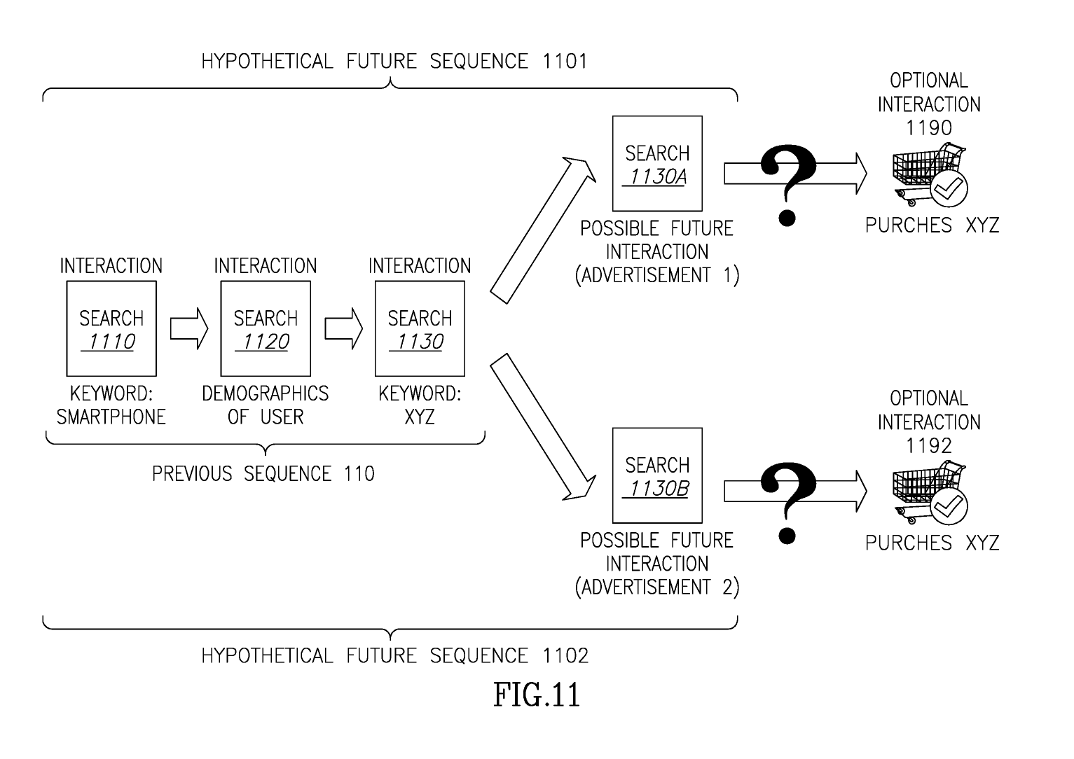

Reference is now made to FIG. 11, which shows a schematic illustration of alternative future sequences of interactions leading to a desired outcome. Defining multiple possible future interactions which may occur after the original sequence of interactions, such as 1110, 1120, and 1130, may be based on the obtained information. The multiple possible future interactions 1130A and 1130B need not include all of the possible future interactions, but rather some interactions (e.g. such which past experience suggest that may yield a favorable result). The selection of the possible future interactions in step 920 of FIG. 9 may be based on the properties of the interactions in the original sequence 1100, on patterns within the original sequence, and possibly on additional data (e.g. data regarding the user, data regarding an advertisement campaign, data regarding costs of such possible future interactions, and/or the like). The multiple possible future interactions defined may include, for example, different types of advertisement and/or advertisement transmitted over different types of advertising channels.

Method 900 of FIG. 9 continues with step 930 of FIG. 9 in which, based on the obtained information and on the multiple possible future interactions, information of interactions may be acquired for each out of a plurality of hypothetical sequence of interactions, wherein each of the hypothetical sequence of interactions includes the original sequence of interactions followed by one or more of the possible future interactions 1101 and 1102. A hypothetical sequence may include more than one possible future interaction. The information obtained in step 930 may include, for example, additional information such as information regarding an event which triggered the execution of method 900 (e.g. an advertisement may be emailed to the user in response to a triggering event).

By selecting one of the possible future interaction the optional desired outcome interaction, such as 1190 and 1192, may be directed.

It may also be understood that the system may be a suitably programmed computer. A computer program being readable by a computer for executing methods, and any variations, may be contemplated. A machine-readable memory tangibly embodying a program of instructions executable by the machine for executing methods, and any variations, may be contemplated.

A computer readable medium may be disclosed, having computer readable code embodied therein for performing a method for attribution of a value associated with a sequence of user interactions to individual interactions in the sequence and/or a predictive method, the computer readable code including instructions for: (a) obtaining information pertaining to interactions which may be included in a sequence of user interactions, wherein at least one of the interactions of the sequence includes communication of digital media over a network connection; (b) attributing an apportionment of the value to each out of a plurality of interactions of the sequence, based on properties relating to at least one interaction out of the sequence of interactions, and (c) computing a performance assessment for the sequence of interactions, based on the obtained information, an assessment scheme, a pattern, and/or the like. Properties include at least one property which may be unrelated to a time in which any of the interactions occurred, thereby enabling efficient utilization of communication resources. An assessment scheme may be based on a statistical analysis of historical data of a plurality of sequence of interactions.

Optionally, the instructions included in the computer readable code for attributing includes instructions for attributing the apportionments of the value based on properties quantifying relative quality of the interactions.

Optionally, the instructions included in the computer readable code for attributing include instructions for attributing the apportionments of the value based on types of advertisement channels used by the respective interactions.

Optionally, the instructions included in the computer readable code for attributing include instructions for attributing the apportionments of the value based on properties of at least one subset of interactions of the sequence, wherein the subset includes multiple interactions.

Optionally, the instructions included in the computer readable code for attributing include instructions for attributing the apportionments of the value based on properties of elements that triggered interactions of the sequence.

Optionally, the instructions included in the computer readable code for attributing include instructions for attributing the apportionments of the value based on properties which pertain to an advertised entity associated with at least one interaction of the sequence of interactions.

Optionally, the instructions included in the computer readable code for attributing include instructions for attributing the apportionments of the value based on properties of at least one keyword entered by a user which triggered at least one interaction of the sequence.

Optionally, the instructions included in the computer readable code for attributing include instructions for attributing the apportionments of the value based on properties which pertain to an advertisement provided to a user in at least one of the interactions of the sequence.

Optionally, the instructions included in the computer readable code for attributing include instructions for attributing the apportionments of the value based on a pattern occurring in at least one property of the interactions across the sequence of interactions.

Optionally, a group of value-sources, on which the value may be based, excludes any value of a sequence closing conversion.

Optionally, the computer readable code further includes instructions for executing, previous to the attributing, dividing interactions of the sequence into multiple groups of interactions, wherein the dividing may be based on the properties of interactions of the sequence; wherein the attributing includes attributing at least one of the apportionments of the value to the respective interaction of the sequence, based on a group to which that interaction was grouped.

Optionally, the instructions included in the computer readable code for dividing include instructions for executing an iterative dividing process that includes subdividing interactions of a group of interactions into multiple subgroups of interactions, wherein the dividing may be based at least partly on attributes of the interactions of the sequence; wherein the attributing may be an iterative process that includes attributing values to interactions of a subgroup based on a value assigned to a group in which the subgroup may be contained.

Optionally, the instructions included in the computer readable code for attributing include instructions for attributing values to interactions of multiple interconnected sequence of user interactions which may be associated with multiple users.

Optionally, the enabling of the efficient utilization of communication resources includes reducing an amount of data communicated to the user, thereby reducing an amount of communication resources.

Optionally, the instructions included in the computer readable code for attributing include instructions for attributing the values may be based on weights which may be determined based on a statistical analysis of historical data of a plurality of sequence of interactions with a plurality of users.

A computer readable code and/or a programmed computer may be executed according to any one of the variations discussed with respect to methods, even though not explicitly elaborated for reasons of brevity of the disclosure.

Optionally, the computer readable code further includes instructions for including determining a weight for each property out of a plurality of properties of sets of interactions, wherein the determining of the weight may be based on frequencies of patterns of interactions having the properties.

Optionally, the computer readable code further includes instructions for determining a weight for each property out of a plurality of properties of sets of interactions, wherein the determining of the weight may be based on relative success of sets of interactions which possess the property executed with respect to success of other sets of interactions.

Optionally, at least one out of the plurality of interactions may be a conversion.

Optionally, the computer readable code further includes instructions for obtaining information indicative of relations between values previously attributed to interactions of a previously analyzed sequence of interactions that may be associated with the conversion; wherein the attributing includes attributing values to interactions of the previously analyzed sequence based on the relations and on a value attributed to the conversion based at least partly on properties of at least one interaction of the sequence.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described herein are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

What is claimed is:

1. A computerized method executed by at least one hardware processor, comprising:
receiving interaction records, wherein each of at least some of the interaction records comprises a cookie value, a URL (Uniform Resource Locator), and a time stamp, wherein said cookie value comprises at least one unique user identifier;
computing, from said interaction records, a plurality of interaction sequences each comprising a plurality of user interactions, wherein:
(a) each adjacent pair of user interactions in each interaction sequence has the same at least one unique user identifier,
(b) at least one property value is computed for each of at least some of said user interactions, and
(c) each of said plurality of interaction sequences is ordered according to said time stamps;
for each of said plurality of interaction sequences:
(a) receiving an identification of a target interaction of the interaction sequence, and a total value associated with said target interaction, and
(b) attributing at least two interaction values to respective at least two user interactions, wherein the sum of attributed interaction values is equal to said total value, and wherein each interaction value is computed using at least one rule, respective property values, and the total value; and
updating at least one bidding property on at least one advertising platform based on said attribution, wherein said at least one bidding property comprises at least one of an advertisement bid value and an advertisement keyword.

2. The computerized method of claim 1, wherein at least one of the user interactions of each interaction sequence comprises a communication of a digital media over a network connection.

3. The computerized method of claim 1, wherein the at least one rule comprises an assessment scheme, wherein the assessment scheme comprises a plurality of rules according to which apportionments of the interaction values may be attributed to two or more of user interactions in the interaction sequence.

4. The computerized method of claim 1, wherein the at least one property value quantifies a relative quality of the respective user interaction.

5. The computerized method of claim 1, wherein the at least one property value comprises types of advertisement channels used by the respective user interaction.

6. The computerized method of claim 1, wherein the each of some of at least one unique user identifier is assigned a user values according to interaction values associated of that user within multiple respective interaction sequences

7. The computerized method of claim 1, wherein the target interaction is a future interaction not recorded in the interaction records.

8. The computerized method of claim 1, wherein the target interaction is one of the user interactions in the interaction sequences.

9. The computerized method of claim 1, wherein the target interaction represents at least on interaction from the group consisting of an impression, a click-through, and a conversion.

10. The computerized method of claim 1, further comprising statistically analyzing the attributions of a plurality of interaction sequence, and determining at least one attribution pattern based on a result of the analyzing.

11. The computerized method of claim 10, wherein the statistical analysis is based on frequencies of attribution patterns of user interactions having similar respective property values.

12. The computerized method of claim 10, wherein the statistical analysis is applied to a subset of user interactions in at least some of the interaction sequences.

13. The computerized method of claim 10, wherein the statistical analysis differentiates between interaction patterns comprising high target interaction values with respect to interaction patterns comprising low target interaction values.

14. The computerized method of claim 1, further comprising:
computing multiple possible future interactions which may occur after the target interaction of a target sequence, wherein each possible future interaction is a server initiated interaction, and wherein each possible future interaction defines a possible future sequence;
computing attributions and a performance assessment for each possible future sequence;
selecting one of the possible future interactions based on the performance assessment; and
executing the selected possible future interaction.

15. The computerized method of claim 14, wherein the selecting comprises selecting an advertisement out of multiple possible advertisements, wherein the executing comprises presenting the selected advertisement to the respective user, and wherein the method is used for retargeting a selected user with an advertisement which is selected based on previous user interactions with the respective user.

16. The computerized method of claim 1, wherein the at least one property value comprises at least one value which is unrelated to a time in which any of the interactions occurred.

17. The computerized method of claim 1, wherein the attributions are performed in a hierarchal manner to at least one subset of multiple user interactions of the interaction sequence.

18. The computerized method of claim 1, wherein the attribution is based on a pattern occurring in at least one property value of the user interactions across the respective interaction sequence.

19. A computerized system, comprising:
an interface;
at least one hardware processor; and
a non-transitory storage medium, comprising instructions executable on said at least one hardware processor, wherein said instructions are configured for:
receiving interaction records, wherein each of at least some of the interaction records comprises a cookie value, a URL (Uniform Resource Locator), and a time stamp, wherein said cookie value comprises at least one unique user identifier;
computing, from said interaction records, a plurality of interaction sequences each comprising a plurality of user interactions, wherein:
(a) each adjacent pair of user interactions in each interaction sequence has the same at least one unique user identifier,
(b) at least one property value is computed for each of at least some of said interaction records, and
(c) each of said plurality of interaction sequences is ordered according to said time stamps;
for each of said plurality of interaction sequences:
(a) receiving an identification of a target interaction of the interaction sequence, and a total value associated with said target interaction, and
(b) attributing at least two interaction values to respective at least two user interactions, wherein the sum of attributed interaction values is equal to said total value, and wherein each interaction value is computed using at least one rule, respective property values, and the total value; and
updating at least one bidding property on at least one advertising platform based on said attribution, wherein said at least one bidding property comprises at least one of an advertisement bid value and an advertisement keyword.

20. A computer program product, stored on a non-transitory computer readable storage medium, wherein the computer program product comprises instructions executable on at least one hardware processor, wherein said instructions are configured for:
receiving interaction records, wherein each of at least some of the interaction records comprises a cookie value, a URL (Uniform Resource Locator), and a time stamp, wherein said cookie value comprises at least one unique user identifier;
computing, from said interaction records, a plurality of interaction sequences each comprising a plurality of user interactions, wherein:
(a) each adjacent pair of user interactions in each interaction sequence has the same at least one unique user identifier,
(b) at least one property value is computed for each of at least some of said interaction records, and
(c) each of said plurality of interaction sequences is ordered according to said time stamps;
for each of said plurality of interaction sequences:
(a) receiving an identification of a target interaction of the interaction sequence, and a total value associated with said target interaction, and
(b) attributing at least two interaction values to respective at least two user interactions, wherein the sum of attributed interaction values is equal to said total value, and wherein each interaction value is computed using at least one rule, respective property values, and the total value; and
updating at least one bidding property on at least one advertising platform based on said attribution, wherein said at least one bidding property comprises at least one of an advertisement bid value and an advertisement keyword.
